(19) United States
(12) Patent Application Publication
(10) Pub. No.: US 2010/0328194 A1
(43) Pub. Date: Dec. 30, 2010

(54) Display device, eyeglass device and video system with them

(76) Inventors: Masanobu INOE, Okayama (JP); Kazuhiro Mihara, Osaka (JP); Hiroshi Mitani, Osaka (JP); Shuji Inoue, Okayama (JP); Seiji Nakazawa, Osaka (JP); Katsuo Saigo, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/626,775

(22) Filed: Nov. 27, 2009

Related U.S. Application Data
(60) Provisional application No. 61/220,896, filed on Jun. 26, 2009.

(30) Foreign Application Priority Data
Jul. 2, 2009 (JP) 2009-157592

(51) Int. Cl. G09G 5/00

(52) U.S. Cl. 345/8

(57) ABSTRACT

The present invention discloses video system including a display device for displaying an video image and an eyeglass device for assisting a viewer in viewing the video image, wherein the display device includes: a display portion for displaying the video image; a first generation portion for generating a synchronizing signal for the video image; and a transmission portion for transmitting the synchronizing signal, the synchronizing signal representing control information with a duration of a continuous active time during which the control information is transmitted, and the eyeglass device includes: a reception portion for receiving the synchronizing signal; an optical filter portion for adjusting an incident light to a left eye and a right eye; a second generation portion for generating an internal signal based on the control information; and a control portion for controlling the optical filter portion based on the internal signal.

### BACKGROUND OF THE INVENTION

1. Field of the Invention

The present invention relates to a technology allowing a viewer to view a video image displayed on a display device through an eyeglass device. More particularly, the present invention relates to a technology with the eyeglass device to switchingly provide the video image on display video for a viewer.

2. Description of the Background Art

Video systems provided with a display device configured to display a video image and an eyeglass device configured to assist a viewer in viewing the video image displayed on the display device are used, for example, to provide a three-dimensional image. Exemplary video systems are disclosed in Japanese Patent Application Laid-open No. H11-98538 and Japanese Patent Application Laid-open No. 2000-36969.

Japanese Patent Application Laid-open Nos. H11-98538 and 2000-36969 disclose technologies for communication between a display device and an eyeglass device. Japanese Patent Application Laid-open No. H11-98538 discloses a technology resolving a problem on a temporal interruption in communication between the display device and the eyeglass device. The eyeglass device disclosed in Japanese Patent Application Laid-open No. H11-98538 generates an internal signal based on a signal from the display device that represents switching of video frames. The eyeglass device controls opening and closing of liquid crystal shutters based on the generated internal signal. As a result, the liquid crystal shutters are favorably controlled even if there is a temporal failure in the signal communication. Thus, a problem resulting from the temporal failure in the signal communication (such as failure to provide a three-dimensional image for a viewer or image flickering) can be reduced. In addition, the eyeglass device disclosed in Japanese Patent Application Laid-open No. H11-98538 is configured to control the liquid crystal shutters using a signal having a plurality of clocks that indicate switching between a video image for the left eye and a video image for the right eye. However, the control provided for the liquid crystal shutters only results in opening one of the left and right liquid crystal shutters at the same time as closing another liquid crystal shutter. Thus, any information required for more sophisticated control is not transmitted from the display device to the eyeglass device.

Japanese Patent Application Laid-open No. 2000-36969 proposes switching opening and closing of left and right shutters of an eyeglass device during a non-display period in a subfield. According to the technology disclosed in Japanese Patent Application Laid-open No. 2000-36969, a viewer may view three-dimensional images even if the viewer uses an eyeglass device with so slow response rate that switching of shutter opening and closing at the same time as a beginning of a subfield may result in blocking light from a plasma display panel (PDP). Japanese Patent Application Laid-open No. 2000-36969, however, does not disclose any technology aiming to transmit information required for more sophisticated control of liquid crystal shutters from video image display devices such as a PDP.

### SUMMARY OF THE INVENTION

With the foregoing in view, an object of the present invention is to provide highly accurate, synchronous control between a display device and an eyeglass device by transmitting information relating to the synchronous control from the display device to the eyeglass device.

A video system according to aspect of the present invention is a video system provided with a display device configured to display an video image and an eyeglass device configured to assist a viewer in viewing the video image, wherein the display device includes: a display portion configured to display the video image; a first generation portion configured to generate a synchronizing signal in synchronization with the video image; and a transmission portion configured to transmit the synchronizing signal, the synchronizing signal representing control information with a duration of a continuous active time during which the control information is transmitted, and the eyeglass device includes: a reception portion configured to receive the synchronizing signal; an optical filter portion configured to adjust an amount of an incident light to a left eye and a right eye; a second generation portion configured to generate an internal signal based on the control information represented with the duration of the continuous active time in the synchronizing signal; and a control portion configured to control the optical filter portion based on the internal signal.

A display device according to another aspect of the present invention is provided with a display portion configured to display a video image; a first generation portion configured to generate a synchronizing signal in synchronization with the video image; and a transmission portion configured to transmit the synchronizing signal, wherein the synchronizing signal represents control information with a duration of a continuous active time during which the control information is continuously transmitted.

An eyeglass device according to yet another aspect of the present invention is provided with a reception portion configured to receive a synchronizing signal in synchronous with a video image; an optical filter portion configured to adjust an amount of an incident light to a left eye and a right eye; a second generation portion configured to generate an internal signal; and a control portion configured to control the optical filter portion based on the internal signal, wherein the synchronizing signal represents control information with a duration of a continuous active time during which the control information is transmitted, and the second generation portion generates the internal signal based on the control information represented with the duration of the continuous active time of the synchronizing signal.

### BRIEF DESCRIPTION OF THE DRAWINGS

FIG. 1 is a schematic block diagram of a video system according to one embodiment of the present invention;

FIG. 2 shows a hardware configuration of a display device and an eyeglass device used in the video system shown in FIG. 1;

FIG. 3 is a function block diagram of the display device used in the video system shown in FIG. 1;

FIG. 4 is a function block diagram of the eyeglass device used in the video system shown in FIG. 1;

FIG. 5 shows transmission of a synchronizing signal from the display device shown in FIG. 1;

FIG. 6A shows a signal waveform of the synchronizing signals shown in FIG. 5;

FIG. 6B shows the signal waveform of the synchronizing signal shown in FIG. 5;

FIG. 6C shows the signal waveform of the synchronizing signal shown in FIG. 5;

FIG. 6D shows the signal waveform of the synchronizing signal shown in FIG. 5;

FIG. 6E shows the signal waveform of the synchronizing signal shown in FIG. 5;

FIG. 7 shows information relating to synchronous control as defined by the waveform of the synchronizing signal shown in FIGS. 6A to 6E;

FIG. 8 is a flow chart of a signal processing step executed by the eyeglass device shown in FIG. 1;

FIG. 9 shows control of an optical filter portion based on the synchronizing signal shown in FIG. 5;

FIG. 10 shows control of the video system according to another embodiment;

FIG. 11 shows control of the video system according to yet another embodiment; and

FIG. 12 shows information relating to the synchronous control as defined by the waveform of the synchronizing signal shown in FIG. 11.

### DETAILED DESCRIPTION OF THE PREFERRED EMBODIMENTS OF THE INVENTION

A video system according to an embodiment of the present invention is described below with reference to the accompanying drawings. It should be noted that the present invention is not limited to configurations, arrangements or forms and the like shown in the drawings as well as descriptions along with them, which are merely intended to facilitate understanding of the principle of the present invention.

### First Embodiment

### 1. Video System Configuration

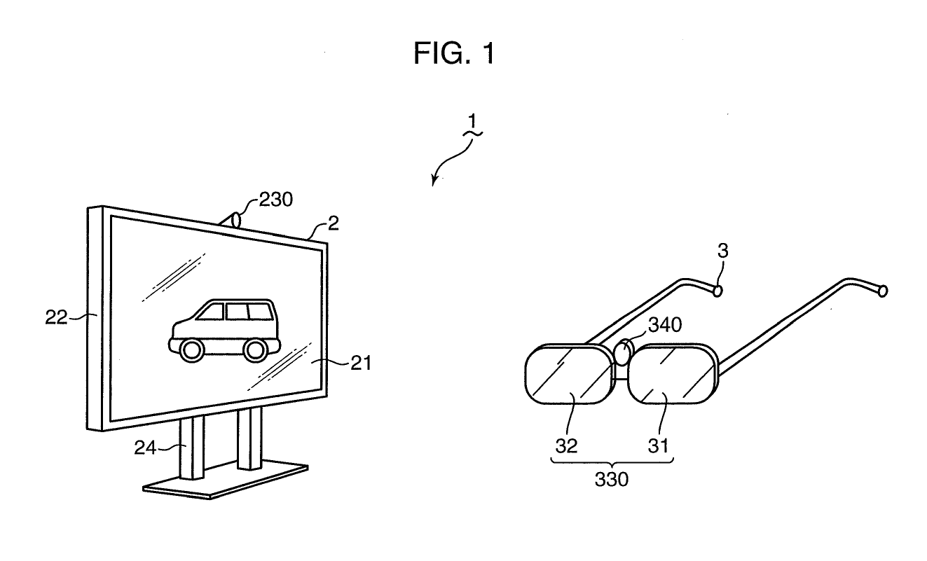

FIG. 1 is a schematic block diagram of a video system according to a first embodiment. The video system 1 comprises a display device 2 configured to display a video image and an eyeglass device 3 configured to assist a viewer in viewing the video image. The viewer wearing the eyeglass device 3 may view the video image displayed on the display device 2. In the present embodiment, the display device 2 displays the video image configured to be three-dimensionally perceived. The viewer wearing the eyeglass device 3 in viewing the video image displayed in the display device 2 three-dimensionally perceives it.

The display device 2 comprises a substantially rectangular display panel 21, a frame 22 surrounding the display panel 21, a transmitter 230 attached to the top of the frame 22, and a leg 24 configured to support the frame 22. The display panel 21 is used as a display portion configured to alternately display (at a frequency of 120 Hz, for example) a video frame to be viewed with the left eye and a video frame to be viewed with the right eye. A synchronizing signal used for synchronizing operation of the eyeglass device 3 with the display of the video image on the display device 2 is transmitted from the transmitter 230 to the eyeglass device 3. It should be noted that the video image to be viewed with the left eye is explained as a first video image and the video image to be viewed with the right eye is explained as a second video image in the present embodiment, but the present invention is not limited thereto. Alternatively the video image to be viewed with the right eye may be designated as the first video image while the video image to be viewed with the left eye may be designated as the second video image. It also should be noted that a video frame for the left eye (to be referred to as “a left eye frame”) and a video frame for the right eye (to be referred to as “a right eye frame”) are alternately displayed in the present embodiment, but the present invention is not limited thereto. Alternatively these frames may also be displayed in a prescribed order.

The eyeglass device 3 substantially looks like a pair of vision corrective eyeglasses. The eyeglass device 3 is provided with an optical filter portion 330 comprising a left eye filter 31 and a right eye filter 32. A receiver 340 configured to receive the synchronizing signal from the transmitter 230 is attached between the left eye filter 31 and the right eye filter 32.

As aforementioned, the display device 2 outputs the video image to the display panel 21 after the video image is subjected to a prescribed processing (such as three-dimensional image processing: 3D image processing). The transmitter 230 of the display device 2 transmits a signal (synchronizing signal) in synchronization with a video image output to the display panel 21. The receiver 340 of the eyeglass device 3 receives the synchronizing signal. The eyeglass device 3 performs a prescribed optical processing on an incident light to the left and right eyes of a viewer based on the synchronizing signal. The left and right optical filters 31 and 32 may open and close in synchronization with the synchronizing signal from the transmitter 230 as a typical optical processing. While a left eye frame is displayed on the display panel 21 of the display device 2, the left eye filter 31 opens so as to increase an amount of a light passing through the left eye filter 31 of the eyeglass device 3 as the right eye filter 32 closes so as to decrease an amount of a light passing through the right eye filter 32. While a right eye frame is displayed on the display panel 21 of the display device 2, the left eye filter 31 closes so as to decrease the amount of the light passing through the left eye filter 31 of the eyeglass device 3 as the right eye filter 32 opens so as to increase the amount of the light passing through the right eye filter 32. Thus the eyeglass device 3 adjusts the amount of the light passing through the left eye filter 31 and the right eye filter 32 in synchronization with the video image output to the display panel 21 by controlling the optical filter portion 330. It should be noted that the term “opening left eye filter 31/right eye filter 32” along with terms analogous thereto used in the following descriptions refer to any operation of the left eye filter 31 or the right eye filter 32 for increasing the amount of the light passing through them. The term “closing left eye filter 31/right eye filter 32” along with terms analogous thereto used in the following descriptions refer to any operation of the left eye filter 31 or the right eye filter 32 for decreasing the amount of the light passing through them.

As aforementioned, in the present embodiment, the left eye frame (left eye image) displayed on the display device 2 contains different contents from the right eye frame (right eye image) by the amount of parallax so that the video system 1 is configured to cause a viewer to three-dimensionally perceive the displayed images. The above-mentioned control of the optical filter portion 330, through which the viewer wearing the eyeglass device 3 views the left eye frame (left eye image) with the left eye and views the right eye frame (right eye image) with the right eye, provides pseudo-parallax that causes the viewer to three-dimensionally perceive the video image displayed by the display device 2. The frame frequency in displaying the left eye frame and the right eye frame in the present embodiment is 120 Hz although the present invention is not limited thereto. Alternatively other frame frequencies such as 96 Hz, 100 Hz, 144 Hz may also be applicable. Further alternatively, the frame frequency may be changed/adjusted corresponding to a type of the video image displayed.

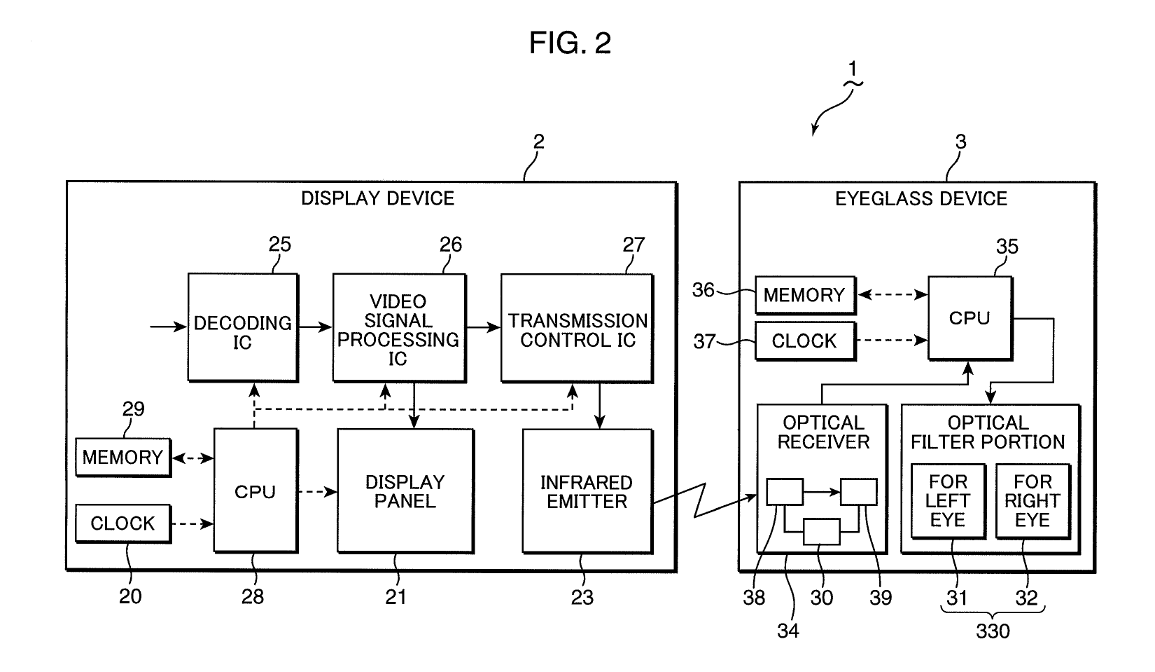

FIG. 2 shows a hardware configuration of the display device 2 and the eyeglass device 3. It should be noted that the present invention is not limited to the hardware configuration shown in FIG. 2, which is merely intended to be exemplary.

The display device 2 comprises a decoding IC 25, a video signal processing IC 26, a transmission control IC 27, a CPU 28, a memory 29, a clock 20, the above-mentioned display panel 21 and an infrared emitter 23 used as the above-mentioned transmitter 230.

An encoded video signal is input to the decoding IC 25 which decodes the input video signal and outputs image data in a prescribed format. The applicable image decoding formats may include MPEG (Motion Picture Experts Group)-2, MPEG-4 and H264, for example.

The video signal processing IC 26 processes video signal for displaying video image data from the decoding IC 25 as a three-dimensional image. For example, the video signal processing IC 26 detects left eye image and the right eye image from the video image decoded by the decoding IC 25. Subsequently, the video signal processing IC 26 alternately rearranges these images. Alternatively, the video signal processing IC 26 may automatically generate images for the left eye and right eye from the video image output by the decoding IC 25. Subsequently, the video signal processing IC 26 converts these images to signals compatible with the display panel 21. In this manner, the video signal processing IC 26 carries out the signal processing required to display the three-dimensional image while also generating the output signals compatible with the input method of the display panel 21.

The video signal processing IC 26 may also execute signal processing other than the signal processing required for displaying the three-dimensional image. For example, the video signal processing IC 26 may carry out processing for adjusting colors of the video image to be displayed corresponding to characteristics of the display panel 21. Alternatively, the video signal processing IC 26 may also interpolate images between image frames generated with the decoding IC 25 to increase an image frame rate.

The transmission control IC 27 generates a synchronizing signal in synchronization with the video image for the left and right eyes generated by the video signal processing IC 26. Subsequently, the transmission control IC 27 outputs the generated synchronizing signal to the infrared emitter 23.

The CPU 28 controls the entire display device 2 in accordance with a program recorded in the memory 29 and/or an external input (not shown) (by controlling elements such as the decoding IC 25 and the video signal processing IC 26 in the display device 2, for example).

The memory 29 is used as a region configured to record the program executed by the CPU 28 along with primary data generated during the course of program execution. Volatile random access memory (RAM) or non-volatile read only memory (ROM) may be used as the memory 29.

The clock 20 generates and supplies a clock signal serving as an operating reference for each IC to the CPU and other elements.

The display panel 21 displays the signal output from the video signal processing IC 26. A conventional CRT, LCD using a liquid crystal element, PDP, organic electroluminescence (EL) or other type of display method may be used for the display panel 21.

The infrared emitter 23 outputs the synchronizing signal to the outside (eyeglass device 3) with an infrared light under the control of the transmission control IC 27.

It should be noted that the present invention is not limited to the infrared light which in the present embodiment is used to establish synchronization between the display device 2 and the eyeglass device 3. The synchronization between the display device 2 and the eyeglass device 3 may also be established using wired signals, radio signals, signals using ultrasonic waves or any other transmission methods.

The eyeglass device 3 comprises a CPU 35, a memory 36, a clock 37, the above-mentioned optical filter portion 330 and an optical receiver 34 used as the above-mentioned receiver 340.

The CPU 35 controls the entire eyeglass device 3 in accordance with a program recorded in the memory 36 and/or an external input (not shown). A peripheral interface controller (PIC) or H8 microcomputer, for example, may be preferably used for the CPU 35.

The memory 36 is used as a region for storing data of the program executed by the CPU 35 and primary data generated during the course of the program execution. Volatile random access memory (RAM) or non-volatile read only memory (ROM) may be used for the memory 36.

The clock 37 generates a clock signal that serves as an operating reference for each element in the eyeglass device 3, and provides the clock signal to each element of the eyeglass device 3. The clock signal may be divided or multiplied as necessary.

The optical receiver 34 receives the synchronizing signal transmitted from the infrared emitter 23 of the display device 2. The optical receiver 34 includes an infrared radiation (IR) sensor 38, an operational amplifier 39 and a power supply circuit 30. The IR sensor 38 generates an electrical signal when receiving the infrared light transmitted from the infrared emitter 23. The operational amplifier 39 amplifies the electrical signal received from the IR sensor 38. The power supply circuit 30 supplies electrical power from a power source (such as a lithium ion battery) installed in the eyeglass device 3 or interrupts the electrical power supply to the IR sensor 38 and the operational amplifier 39 under the control of the CPU 35.

Although the infrared light is used for communication of the synchronizing signal in the present embodiment, in the case a radio signal is used, an element such as an antenna or a tuner capable of receiving the radio signal may be used instead of the IR sensor 38, so that synchronization using the radio signal between the display device 2 and the eyeglass device 3 may be preferably established.

The optical filter portion 330 comprises the left eye filter 31 and the right eye filter 32 as afore-described. The left eye filter 31 and the right eye filter 32 are attached to the eyeglass device 3 so that the left eye filter 31 is arranged in front of the left eye of a viewer wearing the eyeglass device 3 while the right eye filter 32 is arranged in front of the right eye. The left eye filter 31 adjusts an amount of an incident light to the left eye of the viewer while the right eye filter 32 adjusts an amount of an incident light to the right eye of the viewer. The optical filter portion 330 suitably adjusts the amounts of the incidents light to the left and right eyes under the control of the CPU 35, respectively, thereby providing a desirable optical effect for the viewer wearing the eyeglass device 3.

It should be noted that the present invention is not limited to the hardware configuration shown in FIG. 2 in the present embodiment. For example, instead of a plurality of ICs such as the decoding IC 25 and the video signal processing IC 26 shown in FIG. 2, these ICs may be integrated into a single IC. In addition, program processing executed by the CPU according to the present embodiment may be alternatively executed by a programmable logic device (PLD) or a digital signal processor (DSP).

It also should be noted that the present invention is not limited to the display device 2 with the infrared emitter 23 according to the present embodiment. For example, a synchronizing signal transmission device, in which the transmission control IC 27 and the infrared emitter 23 are incorporated, may be provided separately from the display device 2. In this case, the synchronizing signal transmission device outputs the synchronizing signal to the eyeglass device 3 in accordance with information input from the display device 2.

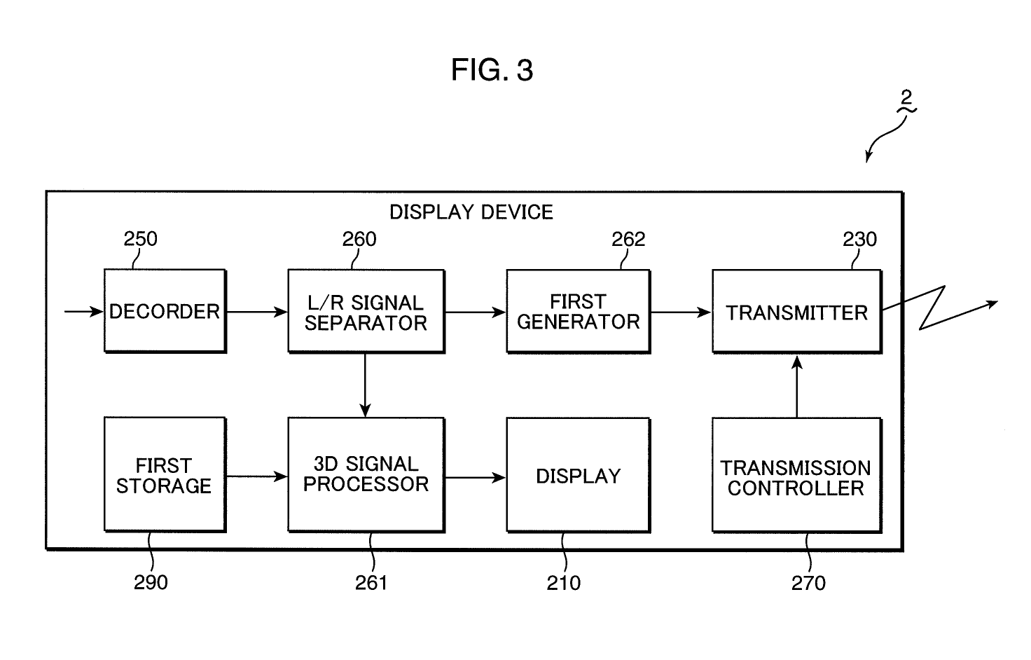

FIG. 3 shows a functional configuration of the display device 2. It should be noted that the present invention is not limited to the functional configuration shown in FIG. 3, which is merely intended to be exemplary.

The display device 2 includes a decoder 250, an L/R signal separator 260, a 3D signal processor 261, a first generator 262, a display 210, a transmitter 230, a transmission controller 270 and a first storage 290.

Encoded video signal is input to the decoder 250 which decodes the input video signal. The decoder 250 corresponds to the decoding IC 25 in the hardware configuration shown in FIG. 2.

The L/R signal separator 260 separates the video signal decoded by the decoder 250 into video signals for the left eye and the right eye or generates video signals for the left eye and the right eye from the video signal decoded by the decoder 250.

The 3D signal processor 261 adjusts the video signals for the left eye and the right eye separated by the L/R signal separator 260, for example, corresponding to characteristics of the display 210 configured to display the video image. The 3D signal processor 261 may adjust parallax between a left eye image and a right eye image, for example, corresponding to a size of the display panel 21 (see FIG. 1) used as the display 210. The 3D signal processor 261 may also detect the amount of the parallax between the left eye frame and the right eye frame.

The first storage 290 may store, for example, a threshold value for the amount of the parallax between the left eye frame and the right eye frame detected by the 3D signal processor 261. The 3D signal processor 261 may determine whether or not the amount of the parallax exceeds the threshold value by comparing the threshold value recorded in the first storage 290 and the detected amount of the parallax. The first storage 290 corresponds to the memory 29 in the hardware configuration shown in FIG. 2.

The first generator 262 generates synchronizing signals that are synchronous with the video images for the left eye and the right eye generated by the L/R signal separator 260, respectively. The first generator 262 may be configured to generate various types of the synchronizing signals with mutually different waveforms, which may define various continuous active times, respectively. During the course of the synchronizing signal generation, the first generator 262 may also adjust the waveform of the synchronizing signal or the timing of their generation according to characteristics of the display panel 21 used as the display 210 or the aforementioned determination of the 3D signal processor 261, for example. In the present embodiment, the continuous active time or the waveform of the synchronizing signal may represent/include control information used for the synchronous control between the display device 2 and the eyeglass device 3.

The L/R signal separator 260, the 3D signal processor 261 and the first generator 262 corresponds to the video signal processing IC 26 in the hardware configuration shown in FIG. 2.

The display 210 corresponds to the display panel 21 described in the context of FIGS. 1 and 2. The display 210 displays the video signal processed by the 3D signal processor 261 in the form of the video image.

The transmitter 230 corresponds to the infrared emitter 23 described in the context of FIG. 2. The transmitter 230 transmits the synchronizing signal generated by the first generator 262 to the outside (eyeglass device 3 (see FIGS. 1 and 2)) under the control of the transmission controller 270.

The transmission controller 270 controls a data volume of the transmitted synchronizing signal while also controlling the transmission interval between synchronizing signal groups comprising a plurality of the synchronizing signals as necessary so that the transmitter 230 intermittently transmits the synchronizing signal groups. The transmission controller 270 corresponds to the transmission control IC 27 in the hardware configuration shown in FIG. 2.

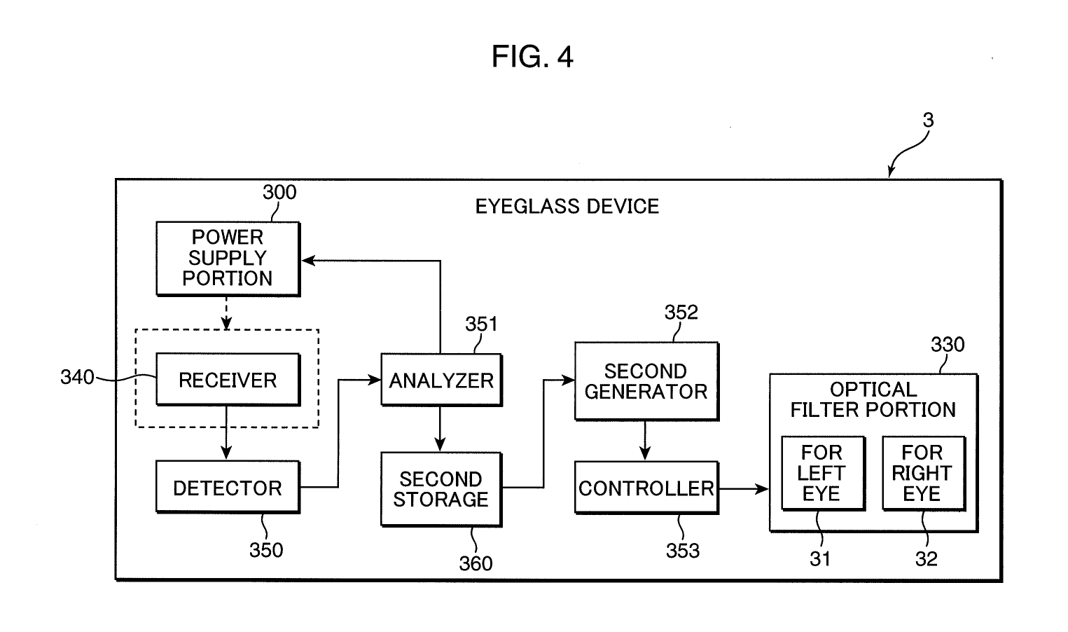

FIG. 4 shows the functional configuration of the eyeglass device 3. The functional configuration of the eyeglass device 3 is described with reference to FIG. 3 together with FIG. 4. It should be noted that the present invention is not limited to the functional configuration shown in FIG. 4, which is merely intended to be exemplary.

The eyeglass device 3 comprises a receiver 340, a detector 350, an analyzer 351, a second storage 360, a second generator 352, a controller 353, an optical filter portion 330 and a power supply portion 300.

The receiver 340 receives the synchronizing signal transmitted with the infrared light from the display device 2. The receiver 340 outputs an electrical signal corresponding to the received infrared light to the detector 350. The receiver 340 corresponds to the IR sensor 38 and the operational amplifier 39 of the optical receiver 34 in the hardware configuration shown in FIG. 2. It should be noted that the present invention is not limited to the infrared light for the communication of the synchronizing signal in the present embodiment as aforementioned. Alternatively any communication technology such as wireless communication may also be used for the communication of the synchronizing signal.

The detector 350 detects the electrical signal generated from the infrared light received by the receiver 340 as the synchronizing signal. For example, a signal with a specific electrical waveform may be detected as the synchronizing signal.

The analyzer 351 measures and/or analyzes a reception time and a continuous active time of the synchronizing signal, for example, based on the clock 37 shown in FIG. 2 as well as the synchronizing signal detected by the detector 350. The analyzer 351 further analyzes information relating to synchronous control between the display device 2 and the eyeglass device 3 based on the continuous active time of the synchronizing signal. Information relating to the synchronous control may typically include information about time interval for operating the optical filter portion 330 (such as a time interval between a generation time of an internal signal used for control to increase an amount of a light passing through the left eye filter 31 to the left eye and a generation time of an internal signal used for control to decrease an amount of a light passing through the left eye filter 31 to the left eye, or a time interval between a generation time of an internal signal used for control to increase an amount of a light passing through the right eye filter 32 to the right eye and a generation time of an internal signal used for control to decrease an amount of a light passing through the right eye filter 32 to the right eye). The analyzer 351 may further transmit a command to the power supply unit 300 as to whether or not power is to be supplied to the receiver 340 based on an analysis result.

The detector 350 and the analyzer 351 correspond to a portion of the program executed by the CPU 35 in the hardware configuration shown in FIG. 2.

The second storage 360 may store data relating to a relationship between the continuous active time (otherwise the waveform) of the synchronizing signal and control for the optical filter portion 330. The analyzer 351 may use data relating to the relationship between the continuous active time (otherwise the waveform) of the synchronizing signal and the control for the optical filter portion 330 to analyze information relating to the synchronous control for the optical filter portion 330 based on the continuous active time of the synchronizing signal. The second storage 360 may further record and retain the analyzed information on the synchronous control and the reception time of the synchronizing signal. The second storage 360 corresponds to the memory 36 in the hardware configuration shown in FIG. 2. The CPU 35 stores the control information in the memory 36.

The second generator 352 generates an internal signal (an internal synchronizing signal) within the eyeglass device 3 based on the control information relating to the synchronous control recorded in the second storage 360 or analyzed by the analyzer 351 and the reception time of the synchronizing signal. The second generator 352 corresponds to the CPU 35 and the clock 37 in the hardware configuration shown in FIG. 2.

The controller 353 controls operation of the optical filter portion 330 in accordance with the internal signal generated by the second generator 352. For example, the left eye filter 31 and the right eye filter 32 of the optical filter portion 330 adjust the amount of the transmitted light under control by the controller 353. The controller 353 corresponds to the program executed by the CPU 35 (program for controlling the optical filter portion 330) or a drive circuit configured to drive the optical filter portion 330, in the hardware configuration shown in FIG. 2.

As aforementioned, the optical filter portion 330 comprises the left eye filter 31 and the right eye filter 32. The left eye filter 31 and the right eye filter 32 adjust the amount of the transmitted light. For example, the left eye filter 31 and the right eye filter 32 adjust the amount or the polarization of the transmitted light. A liquid crystal element, for example, may be used for the left eye filter 31 and the right eye filter 32. The amount of the lights passing through the left eye filter 31 and the right eye filter 32, respectively, is adjusted under control of the liquid crystal elements.

In the present embodiment, the left eye image and the right eye image are alternately switched in display panel 21 by the display device 2. Therefore the left eye filter 31 and the right eye filter 32 may work as shutters configured to alternatively increase and/or decrease the amount of the transmitted light although the present invention is not limited thereto. Alternatively the left eye filter 31 and the right eye filter 32 may also operate so as to change polarization direction of the transmitted light. Further alternatively, the left eye filter 31 and the right eye filter 32 may also carry out another operation for adjustment of the amount of the light passing through the left eye filter 31 and the right eye filter 32 in synchronization with the video image displayed by the display device 2.

The power supply unit 300 receives a command from the analyzer 351 as described above. The power supply unit 300 supplies power to the receiver 340 or interrupts the power supply according to the command from the analyzer 351. The power supply unit 300 corresponds to the power supply circuit 30 of the optical receiver 34 in the hardware configuration shown in FIG. 2.

It should be noted that the present invention is not limited to the functional configurations shown in FIGS. 3 and 4 described according to the present embodiment in which the transmitter 230 and the display 210 are shown incorporated within a single display device 2. Alternatively the transmitter 230 may be incorporated in some device different from the display device 2.

It should be noted that the present invention is not limited to the exemplary relationship between the hardware configuration and the function configuration described in the context of FIGS. 2 through 4. It should be understood that any other hardware configuration and/or functional configuration may be applicable.

### 2. Transmission of The Synchronizing Signal

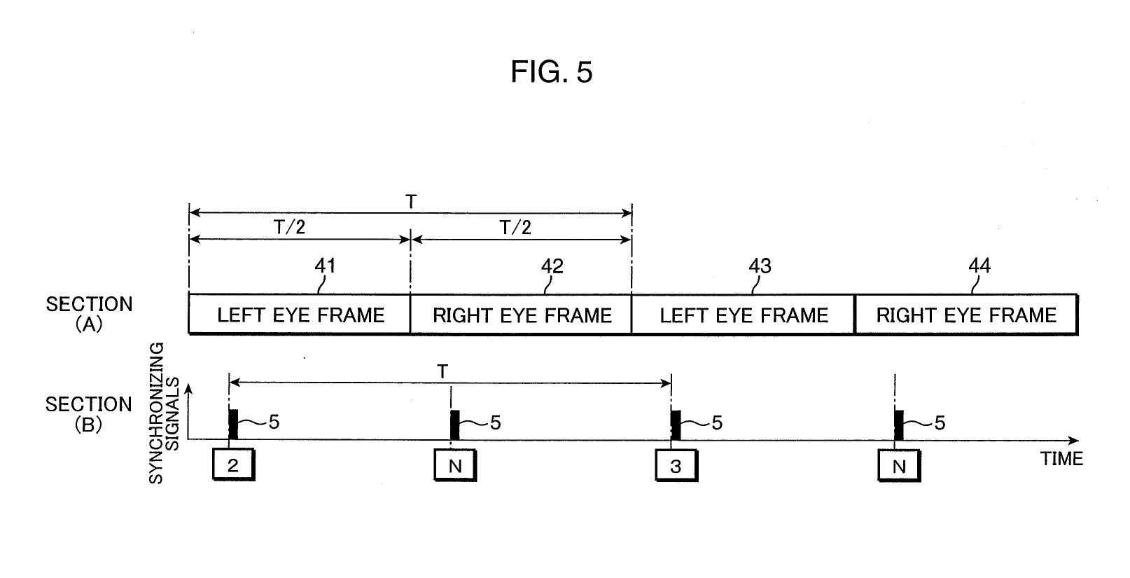

FIG. 5 shows transmission of the synchronizing signal from the display device 2 described in the context of FIGS. 1 to 4. The transmission of the synchronizing signal from the display device 2 and the generation of the internal signal in the eyeglass device 3 are described with reference to FIGS. 3 and 4 together with FIG. 5.

Section (A) of FIG. 5 indicates that the display 210 of the display device 2 alternately displays a left eye frame 41 and a right eye frame 42 sequentially. Section (B) indicates that the transmitter 230 of the display device 2 transmits the synchronizing signals 5 in synchronization with the frames 41 and 42 displayed by the display 210, respectively.

The display device 2 generates and transmits the synchronizing signal 5 in synchronization with the video image displayed by the display 210. The L/R signal separator 260 separates the video signal decoded by the decoder 250 into the video signals of the left frame 41 and the right frame 42. Subsequently, the L/R signal separator 260 adjusts the separated video signals according to the display method of the display 210. For example, the L/R signal separator 260 rearranges the corresponding left eye frame 41 and right eye frame 42 using the video signal decoded by the decoder 250 so as to allow the display 210 to alternately display the left eye frame 41 and the right eye frame 42. For example, as shown in section (A) of FIG. 5, the L/R signal separator 260 rearranges the left eye frame 41 and the right eye frame 42 so that the left eye frame 41 is displayed prior to the right eye frame 42.

The first generator 262 generates the synchronizing signals 5 corresponding to the rearranged order of the left and right frames 41 and 42 by the L/R signal separator 260. Section (B) of FIG. 5 shows the synchronizing signal 5 generated by the first generator 262.

As shown in section (B), the synchronizing signal 5 is generated and transmitted according to the display order and the display timing of the left and right frames 41 and 42 shown in section (A). As shown in section (A), the left eye frame 41 is displayed first followed by the right eye frame 42 corresponding to the preceding left eye frame 41. As shown in section (B), a single synchronizing signal 5 is generated and transmitted in synchronization with each frame 41 and 42. Reference symbols “2”, “N” and “3” are shown along the horizontal axis of section (B). These reference symbols refer to the type of the continuous active time (otherwise the waveform) of the synchronizing signal 5. Different reference symbols mean that the continuous active times (or waveforms) of the synchronizing signals 5 are different.

The display 210 of the display device 2 displays the left eye frame 41. The transmitter 230 transmits the synchronizing signal 5 generated by the first generator 262 at a preferable timing to get the left eye filter 31 of the eyeglass device 3 opened (so that the amount of the light passing through the left eye filter 31 increases). The transmission of the synchronizing signal 5 in synchronization with the left eye frame 41 shown in section (B) delays from a start of displaying the left eye frame 41 but the present invention is not limited thereto. Alternatively the synchronizing signal 5 may also be transmitted at the same time as the start of displaying the left eye frame 41. The amount of the transmission delay (offset time) of the synchronizing signal 5 from the start of displaying the left eye frame 41 may be determined according to characteristics of the display 210 (display panel 21), for example.

The display 210 displays the right eye frame 42 after displaying the left eye frame 41. The transmitter 230 transmits the synchronizing signal 5 generated by the first generator 262 at a preferable timing to get the right eye filter 32 of the eyeglass device 3 opened (so that the amount of the light passing through the right eye filter 32 is increased). The transmission of the synchronizing signal 5 synchronized with the right eye frame 42 shown in section (B) delays from a start of displaying the right eye frame 42, but the present invention is not limited thereto. Alternatively the synchronizing signal 5 may also be transmitted at the same time as the start of displaying the right eye frame 42. The amount of the transmission delay (offset time) of the synchronizing signal 5 from the start of displaying the right eye frame 42 may be determined according to characteristics of the display 210 (display panel 21), for example. The transmission controller 270 controls the transmitter 230 in the present embodiment so that the offset time of the synchronizing signal 5 synchronized with the left eye frame 41 and the offset time of the synchronizing signal 5 synchronized with the right eye frame 42 are substantially equivalent but the present invention is not limited thereto. Alternatively the offset time of the synchronizing signal 5 synchronized with the left eye frame 41 and the offset time of the synchronizing signal 5 synchronized with the right eye frame 42 may also be different.

The display 210 again displays the left eye frame 41 after the right eye frame 42, and the transmitter 230 transmits the synchronizing signal 5 synchronized with the newly displayed left eye frame 41. In this manner, the display device 2 transmits the synchronizing signals 5 in synchronization with the displayed left eye frame 41 and the displayed right eye frame 42, respectively. The eyeglass device 3 adjusts the amount of the incident light to the left eye and/or the right eye by controlling the optical filter portion 330 using the synchronizing signals 5. The time at which the synchronizing signal 5 is received and the continuous active time (otherwise the waveform) of the synchronizing signal 5 defines the timing of the opening and closing of the left eye filter 31 and the right eye filter 32 (timing for increasing or decreasing the amount of the incident light for the left eye and/or the right eye).

### 3. Reception of The Synchronizing Signal

The synchronizing signal 5 from the display device 2 is received by the receiver 340 of the eyeglass device 3. The detector 350 detects the synchronizing signal 5 received by the receiver 340.

The detector 350 converts the infrared light received by the reception portion 340 to an electrical signal. The electrical signal generated by the detector 350 is output to the analyzer 351.

The analyzer 351 analyzes the synchronous control for the optical filter portion 330 corresponding to the continuous active time (otherwise the waveform) of the synchronizing signal 5 detected by the detector 350. The analyzer 351, for example, measures the continuous active time of the input electrical signal and identifies the continuous active time of the synchronizing signal 5 based on the measured continuous active time. The continuous active time may be identified by measuring and/or calculating a time period during which an active electrical signal (such as a high level voltage) continues in a single signal from the clock 37 as a reference.

### 4. Type of The Synchronizing Signal

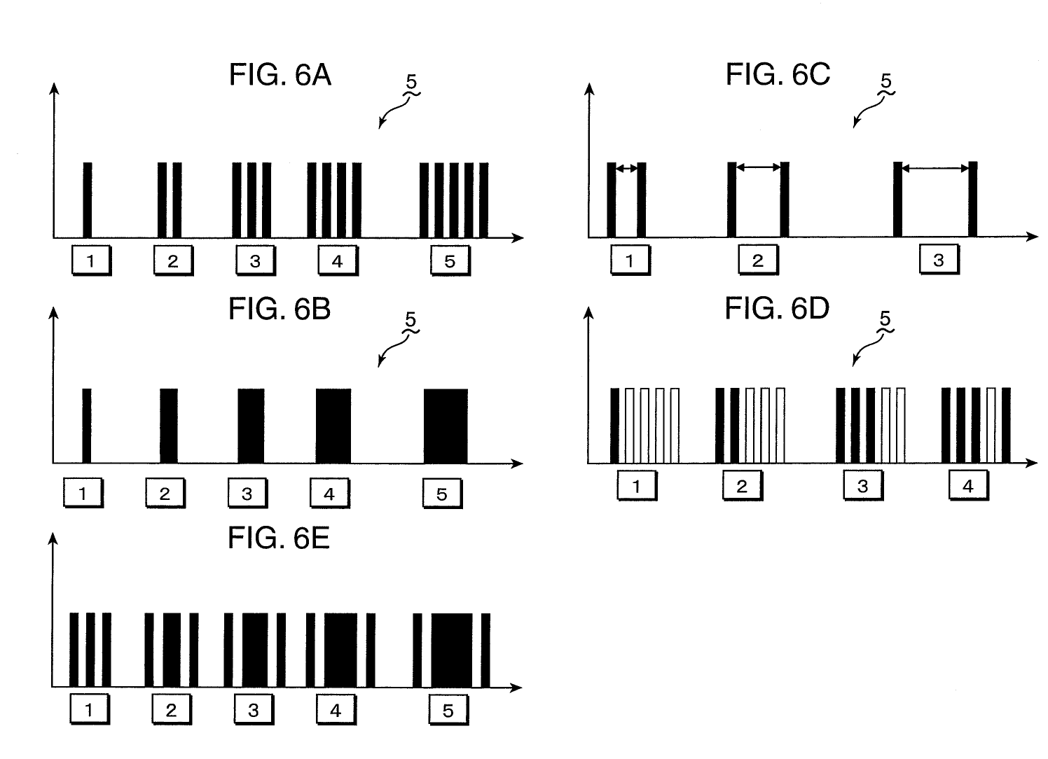

FIGS. 6A to 6E exemplarily indicate various types of the synchronizing signal 5 transmitted by the display device 2. The type of the synchronizing signal 5 is described with reference to FIGS. 2 to 5 together with FIGS. 6A to 6E.

FIG. 6A shows various types of the synchronizing signals 5 with a different number of pulses. The transmitter 230 of the display device 2 transmits the synchronizing signal 5, which contains a single pulse or a plurality of pulses at a fixed time interval, to the receiver 340 of the eyeglass device 3. The period during which the single pulse or the plurality of the pulses at a fixed time interval are transmitted and/or received may be defined as the continuous active time during which the control information used to control the optical filter portion 330 is transmitted. The second storage 360 of the eyeglass device 3 preliminarily stores a threshold value for the time interval between the pulses. The detector 350 determines the rising edge of the first pulse contained in the synchronization signal 5 as a starting point of the synchronization signal 5. If there is no pulse detected after detecting a preceding pulse during the time period defined by the threshold value for the time interval between the pulses, the detector 350 determines the preceding pulse as the last pulse contained in the synchronizing signal. The analyzer 351 subsequently measures the continuous active time of the synchronizing signal 5 by counting the pulses from the first pulse to the last pulse detected by the detector 350. The analyzer 351 further records data relating to the reception time of the synchronizing signal 5 and data relating to the continuous active time of the synchronizing signal 5 (the counted pulses) in the second storage 360 as an analysis result for the continuous active time of the synchronizing signal 5. For example, the synchronizing signal 5 indicated with the reference symbol “2” among the synchronizing signals 5 shown in FIG. 5 may be identified as the synchronizing signal with two pulses shown in FIG. 6A, the synchronizing signal 5 indicated with the reference symbol “3” among the synchronizing signals 5 shown in FIG. 5 may be identified as the synchronizing signal with three pulses shown in FIG. 6A, and the synchronizing signal 5 indicated with the reference symbol “N” among the synchronizing signals 5 shown in FIG. 5 may be identified as the synchronizing signal with N pulses. In this manner, when using the pattern of the synchronizing signal 5 shown in FIG. 6A, the synchronizing signals 5 as many as the number of the pulses may be available.

FIG. 6B shows various types of the synchronizing signals 5 with different pulse time widths (pulse widths). As described in the context of FIGS. 1 to 3, when the infrared light is used for communication of the synchronizing signal 5, the pulse time width is adjusted by controlling the duration of illumination of the infrared emitter 23 of the display device 2 (by using the transmission controller 270, for example).

The analyzer 351 measures a time of a pulse rising edge and a time of a pulse falling edge. The analyzer 351 further measures the time length during which the received synchronizing signal 5 continues to be active (pulse width (the continuous active time of the synchronizing signal)) using the pulse rising and falling edge times. The second storage 360 may also preliminarily store data on the pulse width of the received synchronizing signal 5.

The analyzer 351 identifies the type of the synchronizing signal 5 by comparing the calculated pulse width with data relating to pulse width recorded in the second storage 360. The analyzer 351 further records data relating to a reception time of the synchronizing signal 5 and data relating to the type of the synchronizing signal (pulse width: continuous active time) in the second storage 360 as an analysis result for the waveform of the synchronizing signal 5. For example, the synchronizing signal 5 indicated with the reference symbol “2” among the synchronizing signals 5 shown in FIG. 5 may be identified as the synchronizing signal 5 with the second shortest pulse width shown in FIG. 6B, the synchronizing signal 5 indicated with the reference symbol “3” among the synchronizing signals 5 shown in FIG. 5 may be identified as the synchronizing signal 5 with the third shortest pulse width shown in FIG. 6B, and the synchronizing signal 5 indicated with the reference symbol “N” among the synchronizing signals 5 shown in FIG. 5 may be identified as the synchronizing signal with the Nth shortest pulse width.

FIG. 6C shows various types of the synchronizing signals 5 with different time interval between two consecutive pulses. The synchronizing signal 5 contains a first pulse transmitted first and a second pulse transmitted subsequently. The first pulse represents a start of the synchronizing signal 5 while the second pulse represents an end of the synchronizing signal 5. The detector 350 detects the first pulse received first as a pulse representing the start of the synchronizing signal 5, and detects the second pulse received subsequently as a pulse representing the end of the synchronizing signal 5. The analyzer 351 measures the reception interval between the first and second pulses using the reception time of the first pulse and the reception time of the second pulse. Furthermore, the reception interval between the first pulse and the second pulse may be any one of the time from the rising edge of the first pulse to the rising edge of the second pulse, the time from the falling edge of the first pulse to the rising edge of the second pulse, the time of the falling edge of the first pulse to the rising edge of the second pulse and the time from the falling edge of the first pulse to the falling edge of the second pulse. The reception interval between the first pulse and the second pulse of the synchronizing signal 5 shown in FIG. 6C is used as the above-mentioned continuous active time. The second storage 360 may preliminarily store data on the reception interval between the received first pulse and second pulse. The analyzer 351 determines the continuous active time of the synchronizing signal 5 by comparing the calculated reception interval between the first pulse and the second pulse with the data on the reception interval between the first pulse and the second pulse recorded in the second storage 360. The analyzer 351 further records data relating to the reception time of the synchronizing signal 5 and data relating to the type of synchronizing signal 5 (reception interval between the first pulse and second pulse) in the second storage 360 as an analysis result for the continuous active time of the synchronizing signal 5. For example, the synchronizing signal 5 indicated with the reference symbol “2” among the synchronizing signals 5 shown in FIG. 5 may be identified as the synchronizing signal 5 with the second shortest reception interval between the first and second pulses shown in FIG. 6C, the synchronizing signal 5 indicated with the reference symbol “3” among the synchronizing signals 5 shown in FIG. 5 may be identified as the synchronizing signal 5 with the third shortest reception interval between the first and second pulses shown in FIG. 6C, and the synchronizing signal 5 indicated with the reference symbol “N” among the synchronizing signals 5 shown in FIG. 5 may be identified as the synchronizing signal 5 with the Nth shortest reception interval between the first and second pulses.

FIG. 6D shows various types of the synchronizing signals 5 with different pulse train pattern. Each pulse shown in FIG. 6D may correspond to 1 bit of data. The detector 350 identifies pulses received in a specific time period after the first pulse is received as the synchronizing signal 5. For example, the specific time period after detecting the first pulse may be determined so that one synchronizing signal 5 contains a maximum of five pulses. The analyzer 351 identifies the pulse pattern of the synchronizing signal 5 by measuring the reception time of each pulse contained in the synchronizing signal 5. In the synchronizing signal 5 farthest to the left in FIG. 6D that is indicated with reference symbol “1”, only the first pulse of the five pulses is active, while the other pulses are inactive. In the synchronizing signal 5 indicated with reference symbol “2”, only the first two pulses are active, while the other pulses are inactive. In the synchronizing signal 5 indicated with reference symbol “3”, the first three pulses are active, while the other pulses are inactive. In the synchronizing signal indicated with reference symbol “4” (the synchronizing signal 5 farthest to the right), the first three pulses and the last pulse are active, while the other pulse is inactive. For example, the synchronizing signal 5 indicated with the reference symbol “2” among the synchronizing signals 5 shown in FIG. 5 may be identified as the synchronizing signal 5 with the pulse pattern indicated with reference symbol “2” of FIG. 6D, the synchronizing signal 5 indicated with the reference symbol “3” among the synchronizing signals 5 shown in FIG. 5 may be identified as the synchronizing signal 5 with the pulse pattern indicated with reference symbol “3” of FIG. 6D, and the synchronizing signal 5 indicated with the reference symbol “N” among the synchronizing signals 5 shown in FIG. 5 may be identified as the synchronizing signal 5 with any pulse pattern other than the pulse patterns indicated with reference symbol “2” and reference symbol “3”.

It should be noted that the present invention is not limited to the exemplary waveform of the synchronizing signal 5 indicated in FIGS. 6A to 6D. Communication of the various types of the synchronizing signals 5 may also be carried out by combining the waveforms shown in FIG. 6A to 6D. FIG. 6E indicates the synchronizing signal with a combined waveform of the synchronizing signals 5 shown in FIGS. 6B and 6C.

The synchronizing signal 5 shown in FIG. 6E contains three pulses. Among the three pulses, the initial pulse is expediently referred to as the first pulse, the last pulse is expediently referred to as the second pulse, and the pulse between the first pulse and the second pulse is expediently referred to as the third pulse. The detector 350 detects the three pulses as a single synchronizing signal 5. The detector 350 determines the first pulse as a start point of the synchronizing signal 5 and the second pulse as an end point of the synchronizing signal 5. The analyzer 351 further measures the time during which the received synchronizing signal 5 continue to be active (the continuous active time of the synchronizing signal 5: width of the third pulse) using a time of a rising edge of the third pulse, and a time of a falling edge of the third pulse. The duration of transmission and/or reception of the third pulse in the synchronizing signal 5 shown in FIG. 6E may be defined as the above-mentioned continuous active time. The second storage 360 may preliminarily store data for the width of the received third pulse. The analyzer 351 identifies the type of the synchronizing signal 5 by comparing the width of the received third pulse and the width of the third pulse recorded in the second storage 360. The analyzer 351 further records an analysis result for the waveform of the synchronizing signal 5 as data relating to the reception time of the synchronizing signal 5 and data relating to the type of the synchronizing signal 5 (third pulse width) in the second storage 360. For example, the synchronizing signal 5 indicated with the reference symbol “2” among the synchronizing signals 5 shown in FIG. 5 may be identified as the synchronizing signal 5 with the second shortest third pulse width shown in FIG. 6E, the synchronizing signal 5 indicated with the reference symbol “3” among the synchronizing signals 5 shown in FIG. 5 may be identified as the synchronizing signal 5 with the third shortest third pulse width shown in FIG. 6E, and the synchronizing signal 5 indicated with the reference symbol “N” among the synchronizing signals 5 shown in FIG. 5 may be identified as a synchronizing signal 5 with the Nth shortest third pulse width. The synchronizing signals 5 of FIG. 6E, of which start and end point are clearly defined by the first pulse and the second pulse, are less sensitive to noise, for example.

Any other combination of pulse waveforms than that shown in FIG. 6E may also be applicable to the synchronizing signal 5. For example, identification of the type of the synchronizing signal 5 may also be carried out by combining the pulse number shown in FIG. 6A with the pulse time width shown in FIG. 6B. Alternatively, the communication between the display device 2 and the eyeglass device 3 may also be established with any identifiable types of the synchronizing signal 5.

### 5. Relationship Between Type of Synchronizing Signal and Synchronous Control of Optical Filter Portion

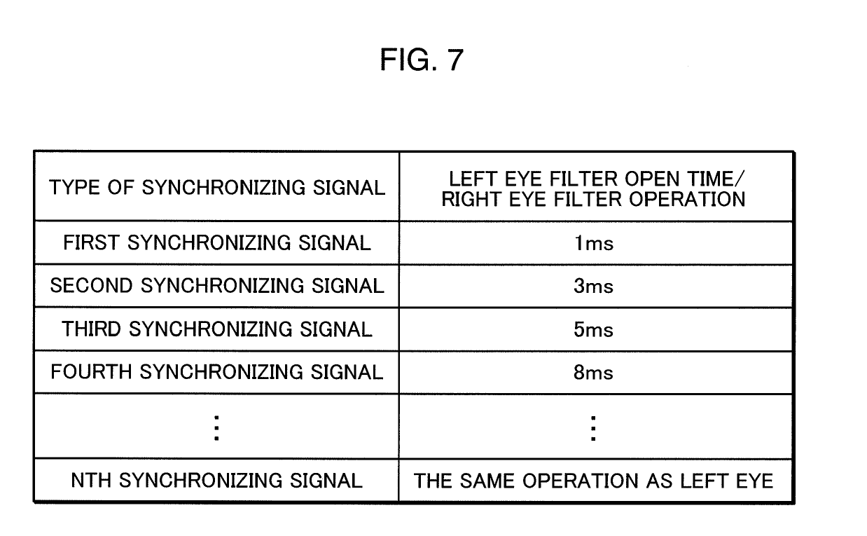

FIG. 7 illustrates the relationship between the type of the synchronizing signal 5 and the synchronous control of the optical filter portion 330. The relationship between the type of the synchronizing signal 5 and the synchronous control of the optical filter portion 330 is described with reference to FIGS. 3 to 6 together with FIG. 7.

Information on the relationship between the type of the synchronizing signal 5 and the synchronous control of the optical filter portion 330 shown in FIG. 7 may be preliminarily recorded in the second storage 360 of the eyeglass device 3. As aforementioned in the context of FIGS. 6A to 6E, the types of synchronizing signal 5 is identified based on the waveform of the synchronizing signal 5. The type of the synchronizing signal 5 is shown in the left column of the table shown in FIG. 7 in the form of the first synchronizing signal to the Nth synchronizing signal. The synchronizing signal 5 indicated with reference symbol “2” shown in FIG. 5 may be the “second synchronizing signal” shown in FIG. 7, the synchronizing signal 5 indicated with reference symbol “3” shown in FIG. 5 may be the “third synchronizing signal” shown in FIG. 7, and the synchronizing signal 5 indicated with reference symbol “N” shown in FIG. 5 may be the “Nth synchronizing signal” shown in FIG. 7.

Operation of the “open time of left eye filter 31” and “operation of right eye filter 32” are shown in the right column of the table shown in FIG. 7. The waveform of the “first synchronizing signal” defines a control to open the left eye filter 31 for 1 ms. The waveform of the “second synchronizing signal” defines a control to open the left eye filter 31 for 3 ms. The waveform of the “third synchronizing signal” defines a control to open the left eye filter 31 for 5 ms. The waveform of the “fourth synchronizing signal” defines a control to open the left eye filter 31 for 8 ms. The waveform of the “Nth synchronizing signal” defines a control for the right eye filter 32 to open as long as the left eye filter 31 opens previously.

After determining the type of the synchronizing signal 5 based on the waveform of the received synchronizing signal 5, the analyzer 351 refers to the information on the relationship between the type of the synchronizing signal 5 and the synchronous control for the optical filter portion 330 recorded in the second storage 360, and records information on the synchronous control defined by the waveform of the synchronizing signal 5 in the second storage 360.

It should be noted that the present invention is not limited to information on the synchronous control defined by the waveform of the synchronous signal 5 obtained on the basis of the information on the type of the synchronizing signal 5 and the synchronous control of the optical filter portion 330 as shown in FIG. 7 of the present embodiment. Alternatively in the case of using the synchronizing signals 5 with mutually different pulse widths as shown in FIG. 6B, the time length for the left eye filter 31 and/or the right eye filter 32 to open may be calculated on the basis of the pulse widths. For example, if the pulse width calculated by the analyzer 351 is 10 μs, then the time length for the left eye filter 31 and/or the right eye filter 32 to open may be 1 ms, while if the pulse width calculated by the analyzer 351 is 20 μs, then the time length for the left eye filter 31 and/or the right eye filter 32 to open may be 2 ms.

### 6. Calculation of Display Cycle

The analyzer 351 may calculate the display time (display cycle T) of a frame set defined as a set of the left eye frame 41 shown in FIG. 5 and the right eye frame displayed immediately after the left eye frame 41. The analyzer 351 may further calculate the display times of the left eye frame 41 and the right eye frame 42 based on the calculated display cycle T if the display times of the left eye frame 41 and the right eye frame 42 contained in the frame set are equivalent.

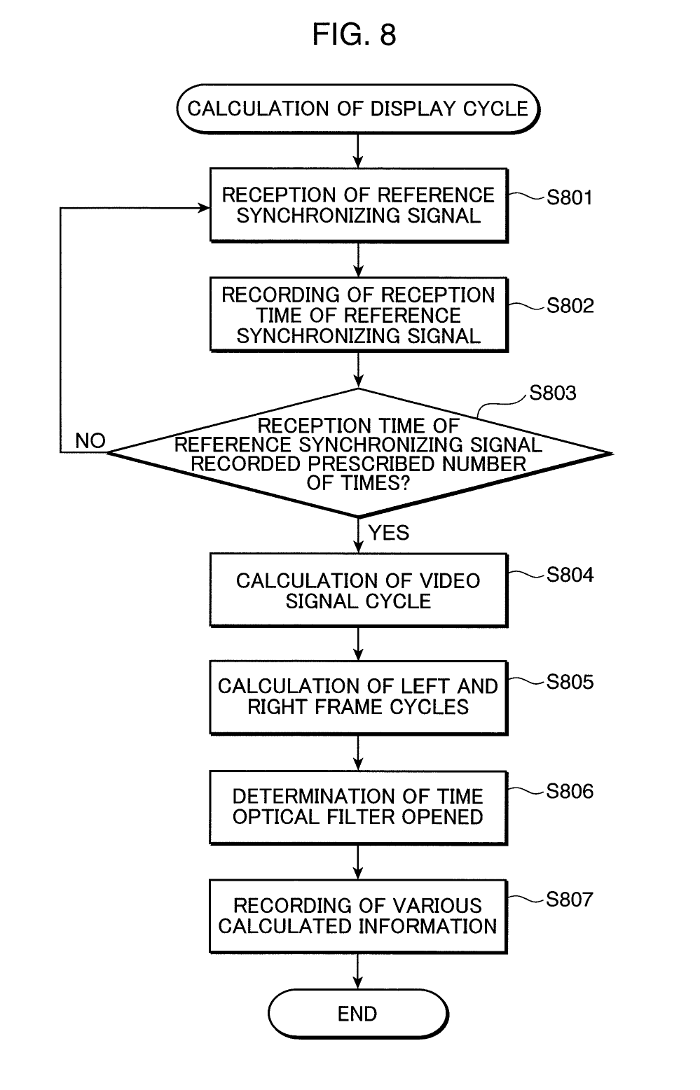

FIG. 8 is a flow chart showing the steps for calculating and analyzing the display cycle T on the basis of the received synchronizing signals 5. The steps for calculating and analyzing the display cycle T are described with reference to FIGS. 2 to 6E together with FIG. 8. The transmission controller 270 of the display device 2 controls transmission of the synchronizing signal 5 so that the time period from a start of displaying the left eye frame 41 to transmission of the synchronizing signal 5 is equivalent to a time period from a start of displaying the right eye frame 42 to transmission of the synchronizing signal 5.

The receiver 340 receives the synchronizing signal 5 (Step S801). For example, in the case of using the pulse pattern shown in FIG. 6D for the synchronizing signal 5, the synchronizing signal 5 of which the second pulse from the start of the synchronizing signal 5 is active (second pulse from left is active) may be identified by the analyzer 351 as the synchronizing signal 5 to be used as a reference for calculating the display cycle T (reference synchronizing signal). In this case, the synchronizing signal 5 indicated with reference symbols “2” and “3” among the synchronizing signals 5 shown in FIG. 5 are used as the reference synchronizing signal 5 in the arithmetic processing steps shown in FIG. 8.

The receiver 340 receives the above-mentioned reference synchronizing signal 5 together with recording the time at which the reference synchronizing signal 5 is received in the second storage 360 (Step S802). For example, the CPU 35 of the eyeglass device 3 may use the clock 37 to obtain time information for the time at which the reference synchronizing signal 5 is received, and temporarily store it in the memory 36.

The analyzer 351 determines whether or not there is a prescribed number of recordings on the received reference synchronizing signal 5 and the reception time in Step S801 and Step S802 (Step S803). Two recordings are used in the analysis by the analyzer 351 described in the context of FIG. 5 but the present invention is not limited thereto. The analyzer 351 may calculate and analyze the display cycle T by using two or more recordings for the received reference synchronizing signal 5 and its reception time. A threshold value for the number of recordings may also be preliminarily recorded in the second storage 360 of the eyeglass device 3, for example.

In the case the number of recordings is less than the prescribed number of recordings, operation returns to Step S801 and the reference synchronizing signal 5 is received again.

Once the prescribed number of the reception times is recorded, the reception interval (time T in FIG. 5) of the reference synchronizing signals 5 is calculated (Step S804). For example, the reception interval of the synchronizing signals 5 is calculated through a difference arithmetic operation on the reception times of the reference synchronizing signals 5. The calculated reception interval is defined as the display cycle T of the left and right eye frames 41 and 42. Although information on two reception times is required to calculate the display cycle T, information on additional reception times may also be used. For example, the analyzer 351 may calculate an average value of the difference between reception times as the display cycle T by using information on three or more reception times. This may enhance accuracy of the display time T.

The analyzer 351 further calculates the display time (cycle) of the left eye frame 41 and the display time (cycle) of the right eye frame 42 by multiplying the display cycle T calculated in Step S804 by ½ (the display times of these frames 41 and 42 are displayed as T/2 in FIG. 5) (Step S805).

As aforementioned in the context of FIGS. 6 to 8, the analyzer 351 analyzes and/or measures the waveform and/or the continuous active time of each received synchronizing signal 5 to determine the operation of the optical filter portion 330 assigned to the analyzed and/or measured waveform and/or the continuous active time (Step S806). For example, if the synchronizing signal 5 is transmitted during the display period of the initial left eye frame 41 shown in FIG. 5, the analyzer 351 recognizes that the left eye filter 31 should be opened for a period of 3 ms after receiving the synchronizing signal 5. If the synchronizing signal 5 is transmitted during the display period of the subsequent left eye frame 41 shown in FIG. 5, the analyzer 351 recognizes that the left eye filter 31 should be opened for 5 ms after receiving the synchronizing signal 5. If the synchronizing signal 5 is transmitted during the display period of the initial right eye frame 42 shown in FIG. 5, the analyzer 351 recognizes that the right eye filter 32 should be opened for a period of 3 ms with emulating the operation of the left eye filter 31 during the preceding display of the left eye frame 41. If the synchronizing signal 5 is transmitted during the display period of the subsequent right eye frame 42 shown in FIG. 5, the analyzer 351 recognizes that the right eye filter 32 should be opened for a period of 5 ms after receiving the synchronizing signal 5 with emulating the operation of the left eye filter 31 during the preceding display of the left eye frame 41.

The analyzer 351 records information on the display cycle T, the display times of the frames 41 and 42, and the opening and closing timing of the optical filters 31 and 32 calculated in each step in the second storage 360 (Step S807).

The eyeglass device 3 may suitably calculate the opening and closing timing of the left and right optical filters 31 and 32 of the optical filter portion 330 simply by receiving the synchronizing signals 5 synchronized to the left eye frame 41 and the right eye frame 42 from the display device 2 through the series of steps shown in FIG. 8. As aforementioned, the waveform of the synchronizing signal 5 defining the synchronous control of the optical filter portion 330 results in successful transmission of information relating to the time period for the left eye frame 41 and/or the right eye frame 42 to be continuously opened from the display device 2 to the eyeglass device 3. Therefore the transmitter 230 does not have to transmit the synchronizing signal 5 for closing the left eye filter 31 and/or the right eye filter 42, which leads to reduction in a communication frequency of the synchronizing signal 5.

### 7. Generation of Internal Signal and Control of Optical Filter Portion

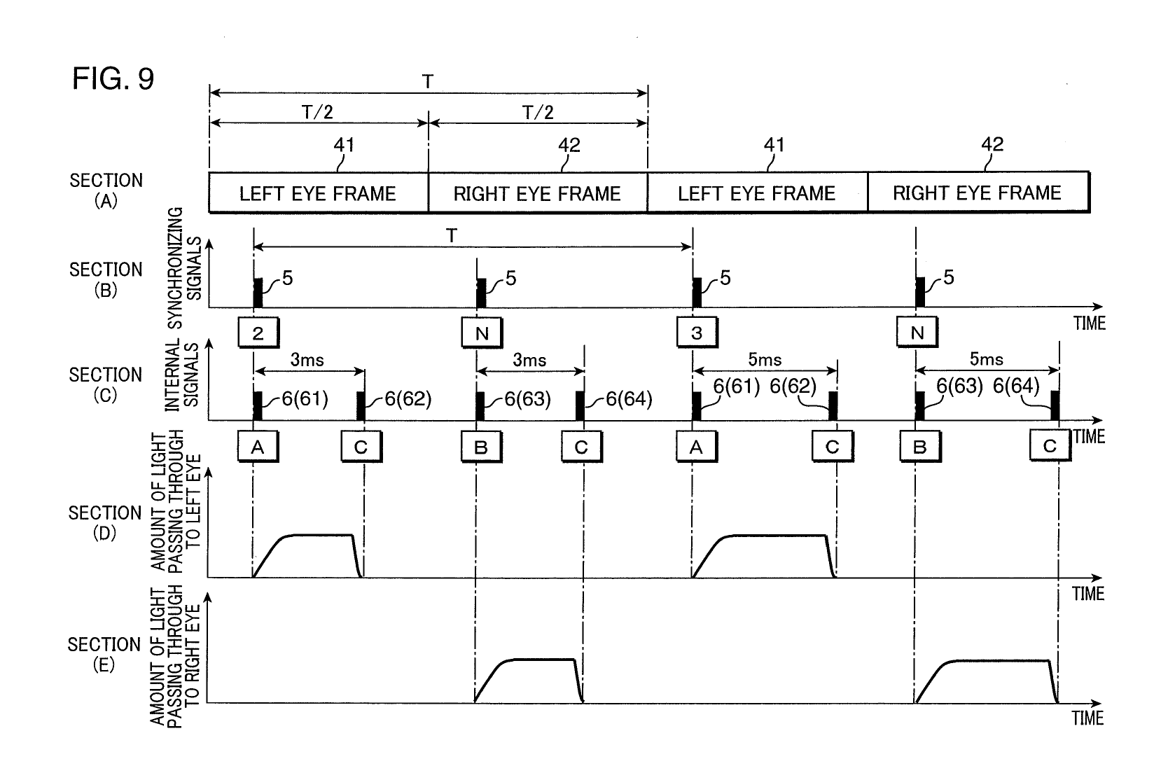

FIG. 9 illustrates the generation of the internal signal by using the synchronizing signal from the display device 2 described in the context of FIGS. 1 to 8. The generation of the internal signal by the eyeglass device 3 and the control of the optical filter portion 330 are described with reference to FIGS. 3 to 7 together with FIG. 9.

Section (A) of FIG. 9 indicates that the display 210 of the display device 2 alternatively displays the left eye frame 41 and the right eye frame 42 sequentially. Section (B) of FIG. 9 indicates that the transmitter 230 of the display device 2 transmits the synchronizing signals 5 in synchronization with the frames 41 and 42 displayed by the display 210 in the same manner as in section (B) of FIG. 5. Section (C) of FIG. 9 indicates the generation of the internal signal 6 based on the synchronizing signal 5. It should be noted that a phase delay is not shown in section (C) of FIG. 9 to clarify the correlation between the synchronizing signal 5 and the internal signal 6, but a phase delay that is an integral multiple of a cycle equivalent to the display periods of the left eye frame 41 and the right eye frame 42 may be present as will be indicated by equations to be described later. Section (D) of FIG. 9 indicates operation of the left eye filter 31 while section (E) of FIG. 9 indicates operation of the right eye filter 32. The vertical axes shown in sections (D) and (E) of FIG. 9 represent the amount of the incident light for the left eye or the right eye, and an increase in the amount of the incident light means that the left eye filter 31 or the right eye filter 32 opens while a decrease in the amount of the incident light means that the left eye filter 31 or the right eye filter 32 closes.

The second generator 352 generates the internal signal 6 within the eyeglass device 3 based on the display cycle T, the display times of the frames 41 and 42, and the opening and closing timings of the optical filters 31 and 32 defined by the waveform of the synchronizing signal 5 (see FIG. 7) stored in the second storage 360. Section (C) of FIG. 9 indicates the internal signal 6 generated by the second generator 352. As described in the context of FIG. 7, the second generator 352 generates an internal signal 61 used for control to open the left eye filter 31 in synchronization with the synchronizing signal 5 received during the display period of the initial left eye frame 41. The second generator 352 further generates an internal signal 62 used for control to close the left eye filter 31 “3 ms” after the internal signal 61 (see FIG. 7) based on the analysis result of the analyzer 351 (such as information on the waveform of the synchronizing signal 5 or information on the reception time of the synchronizing signal 5). The second generator 352 generates an internal signal 63 used for control to open the right eye filter 32 in synchronization with the synchronizing signal 5 received during the display period of the initial right eye frame 42. The second generator 352 further generates an internal signal 64 used for control to close the right eye filter 32 “3 ms” after the internal signal 63 (see FIG. 7) by emulating the preceding operation of the left eye filter 31 based on the analysis result of the analyzer 351.

The second generator 352 generates the internal signal 61 used for control to open the left eye filter 31 in synchronization with the synchronizing signal 5 received during the display period of the subsequent left eye frame 41. The second generator 352 further generates the internal signal 62 used for control to close the left eye filter 31 “5 ms” after the internal signal 61 (see FIG. 7) based on the analysis result of the analyzer 351. The second generator 352 generates the internal signal 63 used for control to open the right eye filter 32 in synchronization with the synchronizing signal 5 received during the display period of the subsequent right eye frame 42. The second generator 352 further generates the internal signal 64 used for control to close the right eye filter 32 “5 ms” after the internal signal 63 (see FIG. 7) by emulating the preceding operation of the left eye filter 31 based on the analysis result of the analyzer 351. It should be noted that the present invention is not limited to the indicated values for the intervals of the internal signals 61, 62, 63 and 64 because they are shown just for the purpose of clarifying the description.

The controller 353 controls the left eye filter 31 and the right eye filter 32 of the optical filter portion 330 based on the internal signals 6 generated by the second generator 352.

In FIG. 9, the left eye filter 31 is controlled on the basis of the internal signal 61 indicated with reference symbol A so that the amount of the light passing through the left eye filter 31 increases. Subsequently, the left eye filter 31 is again controlled on the basis of the internal signal 62 indicated with reference symbol C so that the amount of the light passing through the left eye filter 31 decreases. The right eye filter 32 is controlled on the basis of the internal signal 63 indicated with reference symbol B so that the amount of the light passing through the right eye filter 32 increases. Subsequently, the right eye filter 32 is again controlled on the basis of the internal signal 64 indicated with reference symbol C, and the amount of the light passing through the right eye filter 32 decreases.

As aforementioned, the eyeglass device 3 may control the left and right optical filters 31 and 32 so that the light amount passing through them increases or decreases, in synchronization with the video image of the display 210 based on the synchronizing signal 5 transmitted from the display device 2.

The display device 2 and the eyeglass device 3 according to the present embodiment may carry out the synchronous control for the optical filter portion 330 using a single synchronizing signal 5 for each frame 41 and 42. In comparison with the prior art using a single synchronizing signal 5 every single operation of the optical filter portion 330, the communication technique of the synchronizing signal 5 according to the present embodiment may establish lower-frequency communication of the synchronizing signal 5 between the display device 2 and the eyeglass device 3. Relatively less various waveforms may contribute to simplifying signal processing such as detection and analysis for the synchronizing signal 5. In addition, low-frequency communication of the synchronizing signal 5 may decrease potential interference between the video system 1 and other equipment.

In comparison with a conventional synchronous control in which the right eye filter 32 closes at the same time as opening of the left eye filter 31 (or vice-versa), the present embodiment using the waveform of the synchronizing signal 5 to define the synchronous control of the optical filter portion 330 (defining the time period in which the left eye filter 31 and/or right eye filter 32 is open) may provide more accurate control (or more preferable synchronous control).

The calculation for the display cycle T in Step S804 described in the context of FIG. 8 may be omitted if the display cycle T is fixedly determined in advance. In this case, opening and closing timings of the left eye filter 31 and the right eye filter 32 may be calculated from the predetermined display cycle T.

It should be noted that the present invention is not limited to the technique shown in Step S803 of FIG. 8 to obtain more accurate display cycle T by receiving the synchronizing signal 5 multiple times. If the frequency of the video signal is selected from a frequency group comprising a plurality of predetermined frequencies (such as 96 Hz, 100 Hz, 120 Hz and 144 Hz), the most reliable frequency may be selected by comparing the difference value of the reception times calculated from two received synchronizing signals with the frequencies contained in the frequency group.

It should be noted that the present invention is not limited to the synchronizing signal 5 transmitted when opening the left eye filter 31 (increasing the amount of the transmitted light) and when opening the right eye filter 32 from the display device 2 to the eyeglass device 3 in the first embodiment. Alternatively the synchronizing signal 5 may be transmitted (1) when closing the left eye filter 31 and when closing the right eye filter 32 (when decreasing the amount of the transmitted light), (2) when opening the left eye filter 31 and when closing the right eye filter 32 and (3) when closing the left eye filter 31 and when opening the right eye filter 32.

### Second Embodiment

The second embodiment further simplifies the communication of the synchronizing signal 5. The simplified communication of the synchronizing signal 5 also contributes to simplified signal processing and less interference with a signal from other equipment. The second embodiment uses the communication of the synchronizing signal 5 transmitted just during the display period of the left eye frame 41 while the first embodiment uses communication of the synchronizing signals transmitted in both display periods for the left eye frame 41 and the right eye frame 42. It should be noted that the present invention is not limited to the communication of the synchronizing signal 5 only during the display period of the left eye frame 41. Alternatively the synchronizing signal 5 may also be transmitted only during the display period of the right eye frame 42.

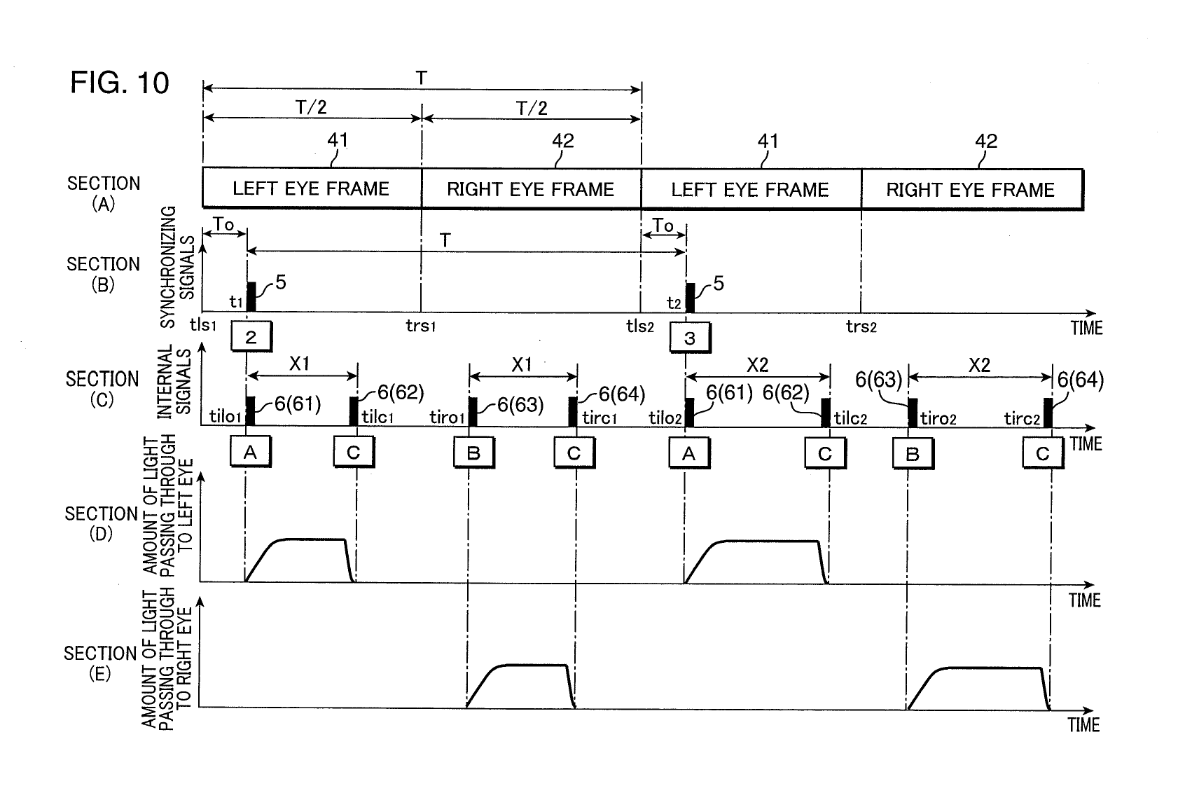

FIG. 10 shows the relationship among frames 41 and 42 displayed on the display 210 of the display device 2, the synchronizing signal 5 transmitted from the transmitter 230 of the display device 2, the internal signal 6 generated by the second generator 352 of the eyeglass device 3, and operation of the optical filter portion 330 of the eyeglass device 3. Section (A) of FIG. 10 shows that the display 210 of the display device 2 alternately displays the left eye frame 41 and the right eye frame 42 sequentially. Section (B) of FIG. 10 shows that the transmitter 230 of the display device 2 transmits the synchronizing signal 5 in synchronization with the frames 41 and 42 displayed by the display 210. Section (C) of FIG. 10 shows the generation of the internal signal 6 based on the synchronizing signal 5. It should be noted that a phase delay is not shown in section (C) of FIG. 10 to clarify the correlation between the synchronizing signal 5 and the internal signal 6 but the phase delay that is an integral multiple of a cycle equivalent to the display periods of the left eye frame 41 and the right eye frame 42 may be present, as will be indicated by the equations to be described later. Section (D) of FIG. 10 shows operation of the left eye filter 31, while section (E) of FIG. 10 shows operation of the right eye filter 32. Control of the optical filter portion 330 is described with reference to FIGS. 2 to 8 together with FIG. 10.

As aforementioned, the transmitter 230 of the display device 2 transmits the synchronizing signal 5 in synchronization with the left eye frame 41. The waveform shown in FIG. 6D, for example, may be applied for the waveform of the transmitted synchronizing signal 5. For example, in FIG. 10, the synchronizing signal 5 indicated with reference symbol “2” may be provided with the pulse pattern indicated by reference symbol “2” shown in FIG. 6D, while the synchronizing signal 5 indicated by reference symbol “3” may be provided with the pulse pattern indicated by reference symbol “3” shown in FIG. 6D. The transmission controller 270 controls the transmitter 230 so that the synchronizing signal 5 is transmitted with a delay of time “To” from a starting time of displaying the left eye frame 41. As aforementioned, the offset time “To” is determined, for example, corresponding to characteristics of the display 210 (such as afterglow characteristics). For example, a large offset time “To” may be set in the case effects of afterglow are large (such as in the case the light from the right eye frame 42 has a comparatively long duration so that a viewer perceives the light of the right eye frame 42 during the display period of the left eye frame 41). The offset time “To” may be constant in the present embodiment. Information relating to the offset time “To” may be preferably preliminarily recorded in the second storage 360 of the eyeglass device 3. Alternatively, information on the offset time “To” may be transmitted with the waveform of the synchronizing signal 5. In this case, the offset time “To” may be considered as a variable value. In the present embodiment, the synchronizing signal 5 transmitted first is received at a time “t₁”, while the subsequently transmitted synchronizing signal 5 is received at a time “t₂”.

The analyzer 351 calculates the display cycle T in the same manner as the technique described in the context of FIGS. 5 and 8. The display cycle T is calculated using, for example, the equation shown below.

T=t₂−t₁ (1)

The analyzer 351 may calculate a starting time “tls₁” of displaying the first left eye frame 41 and a starting time “tls₂” of displaying the subsequent left eye frame 41 using the offset time “To” recorded in the second storage 360. These starting times of displaying the left eye frames 41 are calculated using, for example, the equations shown below.

tls₁=t₁−To (2)

tls₂=t₂−To (3)

The analyzer 351 may further calculate a starting time “trs₁” of displaying the first right eye frame 42 and a starting time “trs₂” of displaying the subsequent right eye frame 42 using the offset time “To” and the starting times “tls₁” and “tls₂” of displaying the left eye frame 41.

$$\begin{matrix}{trs}_{1} = {tls}_{1} + \frac{T}{2} & ( 4 ) \\ {trs}_{2} = {tls}_{2} + \frac{T}{2} & ( 5 )\end{matrix}$$

In the present embodiment, the right eye filter 32 is controlled so as to operate symmetrically with the left eye filter 31 in the same manner as the synchronous control described in the context of FIG. 9. Thus, the second generator 352 generates the internal signals 6 so that the time period from the display starting times “tls₁” and “tls₂” of the left eye frame 41 to closing the left eye filter 31 is equal to the time from the display starting times “trs₁” and “trs₂” of the right eye frame 42 to closing by the right eye filter 32. In addition, in the present embodiment, the left eye filter 31 is controlled so as to open in synchronization with the synchronizing signal 5 (and furthermore, the term to be “in synchronization with” includes synchronization with a phase delay). At this time, a generation time “tilo₁” of the internal signal 61 used for control to open the left eye filter 31 during the display period of the first left eye frame 41, the generation time “tilo₂” of the internal signal 61 used for control to open the left eye filter 31 during the display period of the subsequent left eye frame 41, the generation time “tiro₂” of the internal signal 63 used for control to open the right eye filter 32 during the display period of the first right eye frame 42, and the generation time “tiro₂” of the internal signal 63 used for control to open the right eye filter 32 during the display period of the subsequent right eye frame 42 are calculated using the equations shown below. Furthermore, the term “nT” indicated in the following equations means a phase delay.

$$\begin{matrix}{tilo}_{1} = {t}_{1} + nT & ( 6 ) \\ {tilo}_{2} = {t}_{2} + nT & ( 7 ) \\ {tiro}_{1} = {tilo}_{1} + \frac{T}{2} = {trs}_{1} + To + nT & ( 8 ) \\ {tiro}_{2} = {tilo}_{2} + \frac{T}{2} = {trs}_{2} + To + nT & ( 9 )\end{matrix}$$

The analyzer 351 further reads out time intervals X1 (for the first left eye frame 41) and X2 (for the subsequent left eye frame 41) from the internal signal 61 used for control to open the left eye filter 31 to the internal signal used for control to close the left eye filter 31 as defined by the waveform of the synchronizing signal 5 from the second storage 360 (see FIG. 7). It should be noted that the present invention is not limited to 3 ms for X1 and 5 ms for X2 in the present embodiment.

The generation time “tilc₁” of the internal signal 62 used for control to close the left eye filter 31 during the display period of the first left eye frame 41, the generation time “tilc₂” of the internal signal 62 used for control to close the left eye filter 31 during the display period of the subsequent left eye frame 41, the generation time “tirc₁” of the internal signal 64 used for control to close the right eye filter 32 during the display period of the first right eye frame 42, and the generation time “tirc₂” of the internal signal 64 used for control to open the right eye filter 32 during the display period of the subsequent right eye frame 42 are calculated using the equations shown below.

tilc₁=tilo₁+X1 (10)

tilc₂=tilo₂+X2 (11)

tirc₁=tiro₁+X1 (12)

tirc₂=tiro₂+X2 (13)

The analyzer 351 records data obtained using the above-mentioned equations 1 to 13 in the second storage 360. The second generator 352 generates the internal signals 6 based on the data recorded in the second storage 360. The controller 353 controls the optical filter 330 in accordance with the internal signals 6, and the amounts of the lights passing through the left eye filter 31 and the right eye filter 32 are adjusted as shown in sections (D) and (E) of FIG. 10.

The display device 2 and the eyeglass device 3 according to the present embodiment may carry out the synchronous control of the optical filter portion 330 by using the synchronizing signal 5 in synchronization with one of the left eye frame 41 and the right eye frame 42. In comparison with a conventional technology using a synchronizing signal 5 every operation of the optical filter portion 330, the communication technique of the synchronizing signal 5 according to the present embodiment may establish low-frequency synchronization of the synchronizing signal 5 between the display device 2 and the eyeglass device 3. Less various waveforms may result in more simplified signal processing such as detection and analysis of the synchronizing signal 5. In addition, low-frequency communication of the synchronizing signal 5 may decreases a potential interference between the video system 1 and other equipment.

In comparison with a conventional synchronous control in which the right eye filter 32 is closed at the same time as opening of the left eye filter 31 (or vice-versa), the waveform of the synchronizing signal 5 to define the synchronous control of the optical filter portion 330 (such as the time period during which the left eye filter 31 and/or the right eye filter 32 opens) according to the present invention may provide more accurate synchronous control (or more preferable synchronous control).

The analyzer 351 calculates various data based on the synchronizing signal 5 transmitted during the display period of the left eye frame 41 according to the present embodiment but the present invention is not limited thereto. If the synchronizing signal 5 is in synchronization with the right eye frame 42, a data set is similarly acquired by using the synchronizing signal 5 in synchronization with the right eye frame 42. The starting time of displaying each frame 41 and 42 is calculated according to the present embodiment. Alternatively display ending times may be calculated either in place of or in addition to the display starting times.

It should be noted that the synchronizing signals 5 is transmitted from the display device 2 to the eyeglass device 3 when opening the left eye filter 31 (increasing the amount of the transmitted light) in the second embodiment but the present invention is not limited thereto. Alternatively the synchronizing signal 5 may be transmitted (1) when closing the left eye filter 31 (when decreasing the amount of the transmitted light), (2) when opening the right eye filter 32, and (3) when closing the right eye filter 32.

### Third Embodiment

In this embodiment, the synchronizing signals 5 are transmitted during the respective display periods of the left eye frame 41 and the right eye frame 42 in the same manner as in the first embodiment. The left eye filter 31 and the right eye filter 32 may carry out mutually different operations according to the present embodiment although waveform of the synchronizing signal 5 in synchronization with the right eye frame 42 according to the first embodiment defines operation of the right eye filter 32 as similar operation of the left eye filter 31 during the display period of the preceding left eye frame 41.

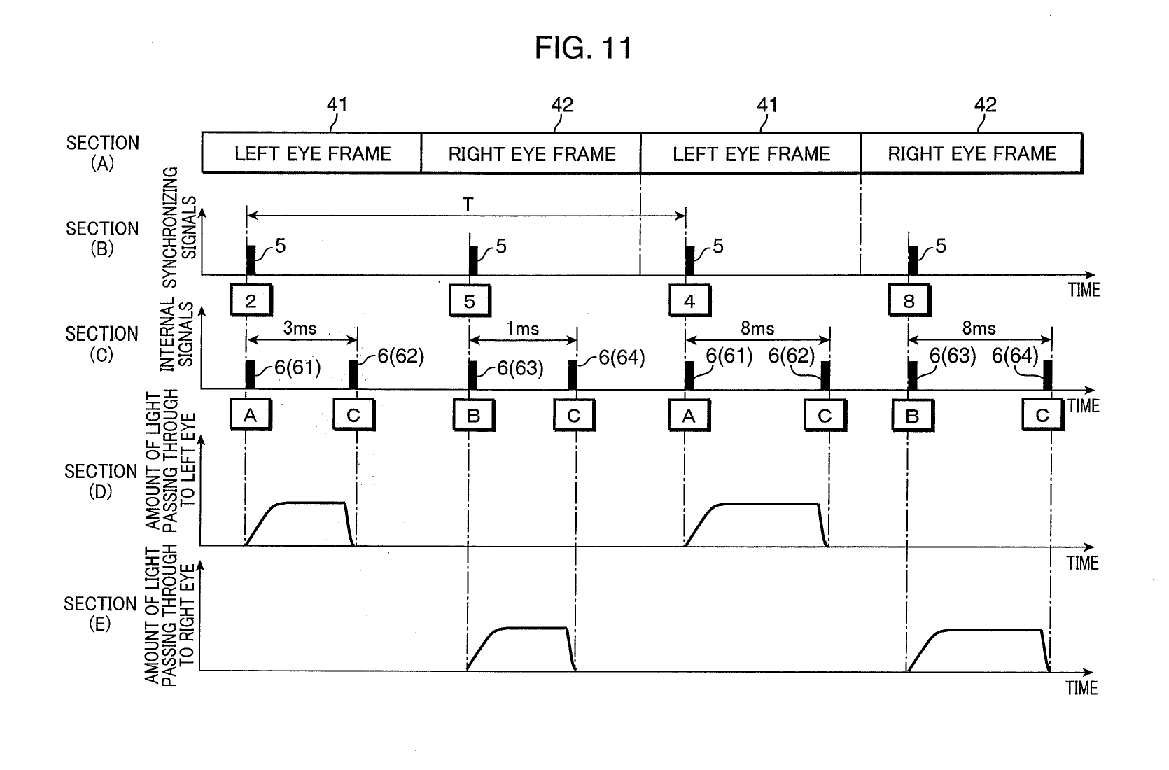

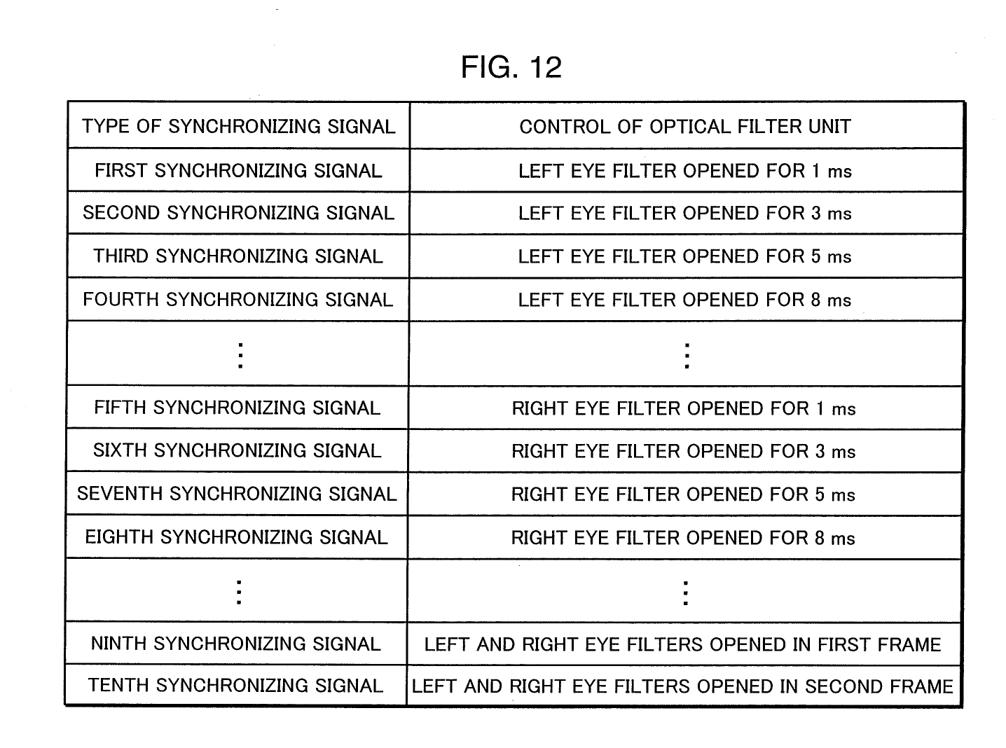

FIG. 11 shows the relationship among frames 41 and 42 displayed on the display 210 of the display device 2, the synchronizing signal 5 transmitted from the transmitter 230 of the display device 2, the internal signal 6 generated by the second generator 352 of the eyeglass device 3, and operation of the optical filter portion 330 of the eyeglass device 3. Section (A) of FIG. 11 shows that the display 210 of the display device 2 alternately displays the left eye frame 41 and the right eye frame 42 sequentially. Section (B) of FIG. 11 shows that the transmitter 230 of the display device 2 transmits the synchronizing signal 5 in synchronization with the frames 41 and 42 displayed by the display 210. Section (C) of FIG. 11 shows that the internal signal 6 is generated based on the synchronizing signal 5. It should be noted that a phase delay is not shown in section (C) of FIG. 11 to clarify the correlation between the synchronizing signal 5 and the internal signal 6 but the phase delay that is an integral multiple of a cycle equivalent to the display periods of the left eye frame 41 and the right eye frame 42 may be present. Section (D) of FIG. 11 shows operation of the left eye filter 31, while section (E) of FIG. 11 shows operation of the right eye filter 32. FIG. 12 shows the correlation between the waveform of the synchronizing signal 5 shown in FIG. 11 and the synchronous control of the optical filter portion 330. The control of the optical filter portion 330 is described with reference to FIGS. 2 to 8 together with FIGS. 11 and 12.

The transmitter 230 of the display device 2 transmits the synchronizing signal 5 in synchronization with each of the left eye frame 41 and the right eye frame 42. The waveforms of the synchronizing signals 5 transmitted during the display periods of frame 41 and 42 are different, respectively. In FIG. 11, the synchronizing signal 5 indicated with reference symbol “2” corresponds to the second synchronizing signal 5 shown in FIG. 12, the synchronizing signal 5 indicated with reference symbol “5” in FIG. 11 corresponds to the fifth synchronizing signal 5 shown in FIG. 12, the synchronizing signal 5 indicated with reference symbol “4” in FIG. 11 corresponds to the fourth synchronizing signal shown in FIG. 12, and the synchronizing signal 5 indicated with reference symbol “8” in FIG. 11 corresponds to the eighth synchronizing signal shown in FIG. 12.

FIG. 12 shows the first to tenth synchronizing signals 5. The first to fourth synchronizing signals 5 are used to control the left eye filter 31. The waveforms of the first to fourth synchronizing signals 5 define mutually different control of the left eye filter 31. The waveform of the first synchronizing signal 5 defines that the time interval between the internal signal 61 for opening the left eye filter 31 and the internal signal 62 for closing the left eye filter 31 should be “1 ms”. The waveform of the second synchronizing signal 5 defines that the time interval between the internal signal 61 for opening the left eye filter 31 and the internal signal 62 for closing the left eye filter 31 should be “3 ms”. The waveform of the third synchronizing signal 5 defines that the time interval between the internal signal 61 for opening the left eye filter 31 and the internal signal 62 for closing the left eye filter 31 should be “5 ms”. The waveform of the fourth synchronizing signal 5 defines that the time interval between the internal signal 61 for opening the left eye filter 31 and the internal signal 62 for closing the left eye filter 31 should be “8 ms”. Thus, the waveforms of the first to fourth synchronizing signals 5 define (1) control of the left eye filter 31 and (2) the time interval between the internal signal 61 for opening the left eye filter 31 and the internal signal 62 for closing the left eye filter 31.

The fifth to eighth synchronizing signals 5 are used to control the right eye filter 32. The waveforms of the fifth to eighth synchronizing signals 5 define mutually different control of the right eye filter 32. The waveform of the fifth synchronizing signal 5 defines that the time interval between the internal signal 63 for opening the right eye filter 32 and the internal signal 64 for closing the right eye filter 32 should be “1 ms”. The waveform of the sixth synchronizing signal 5 defines that the time interval between the internal signal 63 for opening the right eye filter 32 and the internal signal 64 for closing the right eye filter 32 should be “3 ms”. The waveform of the seventh synchronizing signal 5 defines that the time interval between the internal signal 63 for opening the right eye filter 32 and the internal signal 64 for closing the right eye filter 32 should be “5 ms”. The waveform of the eighth synchronizing signal 5 defines that the time interval between the internal signal 63 for opening the right eye filter 32 and the internal signal 64 for closing the right eye filter 32 should be “8 ms”. Thus, the waveforms of the fifth to eighth synchronizing signals 5 define (1) control of the right eye filter 32 and (2) the time interval between the internal signal 63 for opening the right eye filter 32 and the internal signal 64 for closing the right eye filter 32.

The ninth and tenth synchronizing signals 5, which are not used in the present embodiment, may be helpful, for example, to selectively view one of two video images with different contents. Alternatively, the ninth and tenth synchronizing signals 5 may also be used in the case 3D signal processor 261 in the display device 2 detects an excessively large amount of the parallax between the left eye frame 41 and the right eye frame 42 during creating a three-dimensional video image as aforementioned. When the amount of the parallax between the left eye frame 41 and the right eye frame 42 exceeds a threshold value, the first generator 262 may generate the ninth or tenth synchronizing signal 5, and the transmitter 230 may transmit the ninth or tenth synchronizing signal 5. When the ninth or tenth synchronizing signal 5 is received, the eyeglass device 3 carries out control including opening both the left eye filter 31 and the right eye filter 32. As a result, perception of excessively intense three-dimensional images by a viewer is inhibited. Furthermore, eleventh and twelfth synchronizing signals 5 may further be used for control to close both the left eye filter 31 and the right eye filter 32.

Similarly to the first embodiment and the second embodiment, the analyzer 351 records the times at which the synchronizing signal 5 is received in the second storage 360, and the second generator 352 generates the internal signals 61 and 63 to be used for control to open the left eye filter 31 and the right eye filter 32 corresponding to the time at which the synchronizing signal 5 is received.

The analyzer 351 further analyzes and/or measures the waveform and/or the continuous active time of the received synchronizing signal 5, and reads out control for the optical filter portion 330 defined by the waveform of the synchronizing signal 5 from the second storage 360. When the synchronizing signal 5 in synchronization with the first left eye frame 41 is received, a time “3 ms” after the generation time of the internal signal 61 used for control to open the left eye filter 31 is recorded in the second storage 360. When the synchronizing signal 5 in synchronization with the first right eye frame 42 is received, a time “1 ms” after the generation time of the internal signal 63 used for control to open the right eye filter 32 is recorded in the second storage 360. When the synchronizing signal 5 in synchronization with the subsequent left eye frame 41 is received, a time “8 ms” after the generation time of the internal signal 61 used for control to open the left eye filter 31 is recorded in the second storage 360. When the synchronizing signal 5 in synchronization with the subsequent right eye frame 42 is received, a time “8 ms” after the generation time of the internal signal 63 used for control to open the right eye filter 32 is recorded in the second storage 360. In addition to the measurement and/or the analysis by the analyzer 351 based on the waveform and/or the continuous active time of the synchronizing signal 5, the second generator 352 generates the internal signal 62 for closing the left eye filter 31 and the internal signal 64 for closing the right eye filter 32 at the times recorded in the second storage 360.

As shown in sections (D) and (E) of FIG. 11, the controller 353 adjusts the amount of the light passing through the optical filter portion 330 by controlling the optical filter portion 330 based on the internal signals 6.

In the present embodiment, the left eye filter 31 and the right eye filter 32 may be independently controlled by using the synchronizing signals 5 with mutually different waveforms. Thus the present embodiment may achieve relatively complex operations of the left eye filter 31 and the right eye filter 32. Therefore the present embodiment may provide relatively sophisticated control of the optical filter portion 330. In addition, less synchronizing signals 5 transmitted during the display periods of frames 41 and 42 than the prior art may result in more simplified processing of the synchronizing signal 5, which leads to less potential interference with a signal from other equipment.

It should be noted that the present invention is not limited to the synchronizing signal 5 transmitted at the timing at which the left eye filter 31 and/or the right eye filter 32 open, but rather the synchronizing signal 5 may be transmitted at the timing at which the left eye filter 31 and/or the right eye filter 32 closes.

It should be also noted that the present invention is not limited to the display device 2 and the eyeglass device 3 shown in the first to third embodiments. For example, the first to third embodiments may be realized by using a program along with a CPU. In this case, for example, the contents of processing executed by the decoding signal IC 25, the video signal processing IC 26, the transmission control IC 27, the CPU 28 and the CPU 35 that are shown in the context of FIG. 2 are realized in the form of a program run on the CPU.

It should be understood that the descriptions relating to the display device 2 and the eyeglass device 3 in the first to third embodiments also discloses their control methods for a skilled person to practice them. The control methods for the display device 2 and the eyeglass device 3 are not limited to the hardware configuration in the above-mentioned descriptions. Thus, the control method may be applicable to any suitable devices capable of realizing the control methods in the above-mentioned descriptions.

It should be also noted that the present invention is not limited to the waveform of the synchronizing signal 5 in the first to third embodiments defining the time period during which the left eye filter 31 and/or the right eye filter 32 are open. The synchronizing signal 5 may also define information relating to synchronous control other than the time period during which the left eye filter 31 and/or the right eye filter 32 are open. For example, information relating to a video image frame rate or information indicating whether or not a video image is a three-dimensional image may be defined and/or transmitted with waveform of the synchronizing signal 5. The waveform of the synchronizing signal 5 may define and/or transmit information relating to the display device 2, information relating to the displayed video image, information relating to the synchronous control between the display device 2 and the eyeglass device 3, other information for controlling the eyeglass device 3, or any other required information.

The waveforms of the synchronizing signal 5 used in the first to third embodiments are not limited to those explained in the context of FIG. 6, but rather any suitable waveform may be may be applicable as long as the display device 2 generates and the eyeglass device 3 identifies them.

The aforementioned specific embodiments may mainly include the following configurations.

A video system according to one aspect of the above-mentioned embodiments is a video system provided with a display device configured to display an video image and an eyeglass device configured to assist a viewer in viewing the video image, wherein the display device includes: a display portion configured to display the video image; a first generation portion configured to generate a synchronizing signal in synchronization with the video image; and a transmission portion configured to transmit the synchronizing signal, the synchronizing signal representing control information with a duration of a continuous active time during which the control information is transmitted, and the eyeglass device includes: a reception portion configured to receive the synchronizing signal; an optical filter portion configured to adjust an amount of an incident light to a left eye and a right eye; a second generation portion configured to generate an internal signal based on the control information represented with the duration of the continuous active time in the synchronizing signal; and a control portion configured to control the optical filter portion based on the internal signal.

According to the above-mentioned configuration, the eyeglass device assists a viewer in viewing the video image displayed by the display device. The first generation portion of the display device generates a synchronizing signal in synchronization with the video image while the transmission portion of the display portion transmits the synchronizing signal. The reception portion of the eyeglass device receives the synchronizing signals. The synchronizing signal represents the control information with the duration of the continuous active time during which the control information is continuously transmitted. The second generation portion of the eyeglass device generates an internal signal based on the control information of the synchronizing signals. The control portion of the eyeglass device may adjust the amount of the incident light to the left and right eyes by controlling the optical filter portion based on the internal signal. Thus operation of the optical filter portion may be changed with the continuous active time of the synchronizing signal generated by the first generation portion, thereby providing control of the optical filter portion suitable for video image displayed by the display portion.

In the above-mentioned configuration, the video image preferably includes a first video image and a second video image, the first video image includes a first frame containing one of a left eye frame configured to be viewed by the left eye of the viewer and the right eye frame configured to be viewed by the right eye of the viewer, and the second video image includes a second frame containing another of the left eye frame and the right eye frame.

According to the above-mentioned configuration, the first video image includes the first frame containing one of the left eye frame and the right eye frame while the second video image includes the second frame containing another of the left eye frame and right eye frame. Thus, the viewer may view a three-dimensional video image.

In the above-mentioned configuration, the optical filter portion comprises a left eye filter operable to increase or decrease the amount of the incident light to the left eye, and a right eye filter operable to increase or decrease the amount of the incident light to the right eye, the control information of the synchronizing signal represents at least one of a time interval between the internal signal used for control to cause the left eye filter to increase the amount of the incident light to the left eye and the internal signal used for control to cause the left eye filter to decrease the amount of the incident light to the left eye, and a time interval between the internal signal used for control to cause the right eye filter to increase the amount of the incident light to the right eye and the internal signal used for control to cause the right eye filter to decrease the amount of the incident light to the right eye, and the second generation portion generates the internal signal based on the at least one of the time intervals.

According to the above-mentioned configuration, the left eye filter of the optical filter portion operates so as to increase or decrease the amount of the incident light to the left eye. The right eye filter of the optical filter portion operates so as to increase or decrease the amount of the incident light to the right eye. The control information of the synchronizing signal represents the at least one of the time interval between the internal signal used for control to cause the left eye filter to increase the amount of the incident light to the left eye and the internal signal used for control to cause the left eye filter to decrease the amount of the incident light to the left eye, and a time interval between the internal signal used for control to cause the right eye filter to increase the amount of the incident light to the right eye and the internal signal used for control to cause the right eye filter to decrease the amount of the incident light to the right eye. The second generation portion generates the internal signal based on the at least one of the time intervals. Thus at least one of the time interval from when the time the amount of the light passing through the left eye filter to the left eye is increased to the time when it is decreased, and the time interval from when the time the amount of the light passing through the right eye filter to the right eye is increased to the time when it is decreased may be altered according to the continuous active time of the synchronizing signal generated by the first generation portion, thereby providing control of the optical filter portion suitable for the video image displayed by the display portion.

In the above-mentioned configuration, the eyeglass device preferably further comprises an analysis portion configured to measure the continuous active time of the synchronizing signal, the analysis portion determines the at least one of the time intervals based on a predetermined relationship between the continuous active time of the synchronizing signal and the at least one of the time intervals, and the second generation portion generates the internal signal based on the at least one of the time intervals determined by the analysis portion.

According to the above-mentioned configuration, the analysis portion measures the continuous active time of the synchronizing signal to determine the at least one of the time intervals based on the predetermined relationship between the continuous active time of the synchronizing signal and the at least one of a time interval from an generation of the internal signal for causing the left eye filter to increase the amount of the incident light to the left eye to an generation of the internal signal for causing the left eye filter to decrease the amount of the incident light to the left eye, and a time interval from an generation of the internal signal for causing the right eye filter to increase the amount of the incident light to the right eye to an generation of the internal signal for causing the right eye filter to decrease the amount of the incident light to the right eye. The second generation portion generates the internal signal based on the at least one time intervals determined by the analysis portion. Thus, the at least one time intervals among the time interval from the time when the amount of the light passing through the left eye filter to the left eye is increased to the time when it is decreased, and the time interval from the time when the amount of the light passing through the right eye filter to the right eye is increased to the time when it is decreased may be changed according to the continuous active time of the synchronizing signal generated by the first generation portion, thereby providing control of the optical filter portion suitable for the video image displayed by the display portion.

In the above-mentioned configuration, the eyeglass device preferably further comprises an analysis portion configured to measure the continuous active time of the synchronizing signal, the analysis portion multiplies the continuous active time of the synchronizing signal by a predetermined coefficient to calculate the at least one of the time intervals, and the second generation portion generates the internal signal based on the at least one of the time intervals calculated by the analysis portion.

According to the above-mentioned configuration, the analysis portion measures the continuous active time of the synchronizing signal to calculate the at least one of a time interval from an generation of the internal signal used for control to cause the left eye filter to increase the amount of the incident light to the left eye to an generation of the internal signal used for control to cause the left eye filter to decrease the amount of the incident light to the left eye, and a time interval from an generation of the internal signals used for control to cause the right eye filter to increase the amount of the incident light to the right eye to an generation of the internal signals used for control to cause the right eye filter to decrease the amount of the incident light to the right eye, by multiplying the continuous active time of the synchronizing signal by a predetermined coefficient. The second generation portion generates the internal signal based on the at least one of the time interval calculated by the analysis portion. Thus, the at least one of the time interval from the time when the amount of the light passing through the left eye filter to the left eye is increased to the time when it is decreased, and the time interval from the time when the amount of the light passing through the right eye filter to the right eye is increased to the time when it is decreased may be changed according to the continuous active time of the synchronizing signal generated by the first generation portion, thereby providing control of the optical filter portion suitable for the video image displayed by the display portion.

In the above-mentioned configuration, the synchronizing signal preferably includes at least one pulse transmitted at a prescribed time interval, and the analysis portion measures the continuous active time of the synchronizing signal by counting the at least one pulse in the synchronizing signal.

According to the above-mentioned configuration, the analysis portion may measure the continuous active time of the synchronizing signal by counting the at least one pulse contained in the synchronizing signal. Thus, the at least one of the time interval from the time when the amount of the light passing through the left eye filter to the left eye is increased to the time when it is decreased, and the time interval from the time when the amount of the light passing through the right eye filter to the right eye is increased to the time when it is decreased may be altered according to a number of the at least one pulse of the synchronizing signal generated by the first generation portion, thereby providing control of the optical filter portion suitable for the video image displayed by the display portion.

In the above-mentioned configuration, the synchronizing signal preferably includes a pulse with a rising edge and a falling edge, and the analysis portion measures the continuous active time of the synchronizing signal by measuring a time period between the rising edge and the falling edge.

According to the above-mentioned configuration, the analysis portion may measure the continuous active time of the synchronizing signal by measuring the time between the rising edge and the falling edge of the synchronizing signal. Thus the at least one of the time interval from the time when the amount of the light passing through the left eye filter to the left eye is increased to the time when it is decreased, and the time interval from the time when the amount of light passing through the right eye filter to the right eye is increased to the time when it is decreased may be changed according to the time between the rising edge and the falling edge of the synchronizing signal generated by the first generation portion, thereby providing control of the optical filter portion suitable for the video image displayed by the display portion.

In the above-mentioned configuration, the synchronizing signal preferably includes a first pulse for representing a start of the synchronizing signal and a second pulse for representing an end of the synchronizing signal, and the analysis portion measures a time interval between the first pulse and the second pulse for the continuous active time of the synchronizing signal.

According to the above-mentioned configuration, the analysis portion may measure the time interval between the first pulse and the second pulse for the continuous active time of the synchronizing signal. Thus, the at least one of the time interval from the time when the amount of the light passing through the left eye filter to the left eye is increased to the time when it is decreased, and the time interval from the time when the amount of the light passing through the right eye filter to the right eye is increased to the time when it is decreased may be altered according to the time interval between the first pulse and the second pulse of the synchronizing signal generated by the first generation portion, thereby providing control of the optical filter portion suitable for the video image displayed by the display portion.

In the above-mentioned configuration, the synchronizing signal preferably includes a first pulse for representing a start of the synchronizing signal, a second pulse for representing an end of the synchronizing signal and a third pulse transmitted between the first pulse and the second pulse and used for a measurement of the continuous active time by the analysis portion, and the analysis portion measures the continuous active time of the synchronizing signal by measuring a time period between a rising edge and a falling edge of the third pulse.

According to the above-mentioned configuration, the analysis portion may measure the time between the rising edge and the falling edge of a third pulse for the continuous active time of the synchronizing signal. Thus, the at least one of the time interval from the time when the amount of the light passing through the left eye filter to the left eye is increased to the time when it is decreased, and the time interval from the time when the amount of the light passing through the right eye filter to the right eye is increased to the time when it is decreased may be changed according to the time between the rising edge and the falling edge of the third pulse generated by the first generation portion, thereby providing control of the optical filter portion suitable for the video image displayed by the display portion. In addition, more accurate measurement of the continuous active time by the analysis portion may be achieved because start and end of the synchronizing signal is clearly defined by the first pulse and the second pulse.

A display device according to another aspect of the above-mentioned embodiments is provided with a display portion configured to display a video image; a first generation portion configured to generate a synchronizing signal in synchronization with the video image; and a transmission portion configured to transmit the synchronizing signal, wherein the synchronizing signal represents control information with a duration of a continuous active time during which the control information is continuously transmitted.

According to the above-mentioned configuration, the first generation portion of the display device generates the synchronizing signal in synchronization with the video image displayed by the display portion, and the transmission portion of the display device transmits the synchronizing signal. The synchronizing signal represents the control information with the continuous active time during which control information. Therefore various synchronous control may be provided by changing the continuous active time of the synchronizing signal.

In the above-mentioned configuration, the video image preferably comprises a first video image and a second video image, the first video image includes a first frame containing one of a left eye frame configured to be viewed by a left eye of a viewer and a right eye frame configured to be viewed by a right eye of the viewer, and the second video image includes a second frame containing another of the left eye frame and right eye frame.

According to the above-mentioned configuration, the first video image includes the first frame containing one of the left eye frame and the right eye frame, and the second video includes the second frame containing another of the left eye frame and the right eye frame. Thus, a viewer may view a three-dimensional video image.

An eyeglass device according to yet another aspect of the above-mentioned embodiments is provided with a reception portion configured to receive a synchronizing signal in synchronous with a video image; an optical filter portion configured to adjust an amount of an incident light to a left eye and a right eye; a second generation portion configured to generate an internal signal; and a control portion configured to control the optical filter portion based on the internal signal, wherein the synchronizing signal represents control information with a duration of a continuous active time during which the control information is transmitted, and the second generation portion generates the internal signal based on the control information represented with the duration of the continuous active time of the synchronizing signal.

According to the above-mentioned configuration, the reception portion of the eyeglass device receives the synchronizing signal. The synchronizing signal received by the reception portion represents the control information with the duration of the continuous active time during which the control information is continuously transmitted. The second generation portion generates the internal signal based on the continuous active time of the synchronizing signal, and the control portion controls the optical filter portion of the eyeglass device based on the internal signal. Thus, operation of the optical filter portion may be changed according to the duration of the continuous active time, thereby providing control of the optical filter portion suitable for the video image.

In the above-mentioned configuration, the video image includes a first video image and a second video image, the first video image includes a first frame containing one of a left eye frame configured to be viewed by the left eye of a viewer and a right eye frame configured to be viewed by the right eye of the viewer, and the second video image includes a second frame containing another of the left eye frame and the right eye frame.

According to the above-mentioned configuration, the first video image includes the first frame containing one of the left eye frame and a right eye frame, and the second video includes a second frame another of the left eye frame and right eye frame. Thus, a viewer may view a three-dimensional video image.

This application is based on U.S. Provisional Application No. 61/220,896 filed on Jun. 26, 2009 and Japanese Patent Application No. 2009-157592 filed on Jul. 2, 2009, the contents of which are hereby incorporated by reference.

Furthermore, the specific embodiments or examples described in the detailed description of the preferred embodiments of the invention are merely intended to clarify the technical contents of the present invention, and are not to be considered in the narrow sense as being limiting. The prevent invention can be modified in various ways without departing from the spirit of the present invention and within the scope of the appended claims.

What is claimed is:

1. A video system comprising a display device configured to display an video image and an eyeglass device configured to assist a viewer in viewing the video image,
wherein the display device includes:
a display portion configured to display the video image;
a first generation portion configured to generate a synchronizing signal in synchronization with the video image; and
a transmission portion configured to transmit the synchronizing signal, the synchronizing signal representing control information with a duration of a continuous active time during which the control information is transmitted, and
the eyeglass device includes:
a reception portion configured to receive the synchronizing signal;
an optical filter portion configured to adjust an amount of an incident light to a left eye and a right eye;
a second generation portion configured to generate an internal signal based on the control information represented with the duration of the continuous active time in the synchronizing signal; and
a control portion configured to control the optical filter portion based on the internal signal.

2. The video system according to claim 1, wherein
the video image includes a first video image and a second video image,
the first video image includes a first frame containing one of a left eye frame configured to be viewed by the left eye of the viewer and the right eye frame configured to be viewed by the right eye of the viewer, and
the second video image includes a second frame containing another of the left eye frame and the right eye frame.

3. The video system according to claim 2, wherein
the optical filter portion comprises a left eye filter operable to increase or decrease the amount of the incident light to the left eye, and a right eye filter operable to increase or decrease the amount of the incident light to the right eye,
the control information of the synchronizing signal represents at least one of a time interval between the internal signal used for control to cause the left eye filter to increase the amount of the incident light to the left eye and the internal signal used for control to cause the left eye filter to decrease the amount of the incident light to the left eye, and a time interval between the internal signal used for control to cause the right eye filter to increase the amount of the incident light to the right eye and the internal signal used for control to cause the right eye filter to decrease the amount of the incident light to the right eye, and
the second generation portion generates the internal signal based on the at least one of the time intervals.

4. The video system according to claim 3, wherein
the eyeglass device further comprises an analysis portion configured to measure the continuous active time of the synchronizing signal,
the analysis portion determines the at least one of the time intervals based on a predetermined relationship between the continuous active time of the synchronizing signal and the at least one of the time intervals, and
the second generation portion generates the internal signal based on the at least one of the time intervals determined by the analysis portion.

5. The video system according to claim 3, wherein
the eyeglass device further comprises an analysis portion configured to measure the continuous active time of the synchronizing signal,
the analysis portion multiplies the continuous active time of the synchronizing signal by a predetermined coefficient to calculate the at least one of the time intervals, and
the second generation portion generates the internal signal based on the at least one of the time intervals calculated by the analysis portion.

6. The video system according to claim 4, wherein
the synchronizing signal includes at least one pulse transmitted at a prescribed time interval, and
the analysis portion measures the continuous active time of the synchronizing signal by counting the at least one pulse in the synchronizing signal.

7. The video system according to claim 4, wherein
the synchronizing signal includes a pulse with a rising edge and a falling edge, and
the analysis portion measures the continuous active time of the synchronizing signal by measuring a time period between the rising edge and the falling edge.

8. The video system according to claim 4, wherein
the synchronizing signal includes a first pulse for representing a start of the synchronizing signal and a second pulse for representing an end of the synchronizing signal, and
the analysis portion measures a time interval between the first pulse and the second pulse for the continuous active time of the synchronizing signal.

9. The video system according to claim 4, wherein
the synchronizing signal includes a first pulse for representing a start of the synchronizing signal, a second pulse for representing an end of the synchronizing signal and a third pulse transmitted between the first pulse and the second pulse and used for a measurement of the continuous active time by the analysis portion, and
the analysis portion measures the continuous active time of the synchronizing signal by measuring a time period between a rising edge and a falling edge of the third pulse.

10. A display device, comprising:
a display portion configured to display a video image;
a first generation portion configured to generate a synchronizing signal in synchronization with the video image; and
a transmission portion configured to transmit the synchronizing signal,
wherein the synchronizing signal represents control information with a duration of a continuous active time during which the control information is continuously transmitted.

11. The display device according to claim 10, wherein
the video image comprises a first video image and a second video image,
the first video image includes a first frame containing one of a left eye frame configured to be viewed by a left eye of a viewer and a right eye frame configured to be viewed by a right eye of the viewer, and
the second video image includes a second frame containing another of the left eye frame and right eye frame.

12. An eyeglass device, comprising:
a reception portion configured to receive a synchronizing signal in synchronous with a video image;
an optical filter portion configured to adjust an amount of an incident light to a left eye and a right eye;
a second generation portion configured to generate an internal signal; and
a control portion configured to control the optical filter portion based on the internal signal,
wherein the synchronizing signal represents control information with a duration of a continuous active time during which the control information is transmitted, and
the second generation portion generates the internal signal based on the control information represented with the duration of the continuous active time of the synchronizing signal.

13. The eyeglass device according to claim 12, wherein
the video image includes a first video image and a second video image,
the first video image includes a first frame containing one of a left eye frame configured to be viewed by the left eye of a viewer and a right eye frame configured to be viewed by the right eye of the viewer, and
the second video image includes a second frame containing another of the left eye frame and the right eye frame.
